(19) United States
(12) Patent Application Publication
(10) Pub. No.: US 2025/0070904 A1
(43) Pub. Date: Feb. 27, 2025

(54) TIME SYNCHRONIZATION TECHNIQUES AND TIMING REFERENCE UNIT FOR 5G NETWORKS

(71) Applicants: Stephen T. Palermo, Chandler, AZ (US); Valerie J. Parker, Portland, OR (US)

(72) Inventors: Stephen T. Palermo, Chandler, AZ (US); Valerie J. Parker, Portland, OR (US)

(21) Appl. No.: 18/944,946

(22) Filed: Nov. 12, 2024

Related U.S. Application Data
(63) Continuation of application No. 63/548,323, filed on Nov. 13, 2023.

(51) Int. Cl. H04J 3/06; H04L 5/00; H04W 56/00; H04W 84/06

(52) U.S. Cl. CPC H04J 3/0667; H04L 5/0051; H04W 56/004; H04W 84/06

(57) ABSTRACT

An apparatus and method for time synchronization in 5^{th} generation (5G) networks are presented. Time sync Reference Unit (TRU) instances are used to calculate synchronization deltas between Radio Units (RUs) and Distributed Units (DUs) and time offsets between antennas of an RU. Time synchronization data are collected from the antennas with reference signals synchronized using precision time protocol (PTP) signals, deltas calculated, and averaged to determine a synchronization offset that is applied to adjust the timing of the RUs and DUs. An artificial intelligence (AI) model is used to process timing data, accounting for environmental and network variables. The synchronization offsets are published for application adjustments, and feedback is collected to refine the AI model and enhance future synchronization accuracy.

### PRIORITY CLAIM

This application claims the benefit of priority to: U.S. Provisional Patent Application No. 63/548,323, filed Nov. 13, 2023, and titled “TIME SYNCHRONIZATION TECHNIQUES AND TIMING REFERENCE UNIT FOR 5G NETWORKS”, which is incorporated herein by reference in its entirety.

### BACKGROUND

Various approaches are being investigated for new deployments and capabilities of 5G New Radio (5G NR) mobile data networks. 5G promises network densification, and 5G NR includes more bands than previous wireless network standards to transmit data. However, higher bandwidth (especially mmWave) propagation causes higher path loss. More 5G deployments have led to the imposition of an increased number of base stations (BSs) operating as 5th generation NodeBs (gNBs). A base station is connected to the 5G core network (CN), such as through a wired or fiber connection; however, not all base stations can be reached with wired or fiber connections because of location and trenching costs, or because the base stations are located in remote or temporary areas.

Based on these and other real-world constraints, the 3rd Generation Partnership Project (3GPP) has proposed the use of wireless Integrated Access Backhaul (IAB) via nodes that use wireless backhaul instead of fiber. Some implementations of IAB, for example, use the same access frequencies (e.g., frequency range 1 (FR1) and/or FR2) for wireless backhaul to connect BSs. In Release 18 3GPP introduced the concept of mobile integrated access backhaul (mIAB) nodes to enable the use of IAB nodes on-demand at mobile locations.

One of the technical issues occurring within these IAB and other deployments involves incorrect time synchronization (“time sync”) among nodes. Time sync issues, in particular, may be encountered when multiple cells or Radio Units (RUs) of a Distributed Unit (DU) provide network access to user equipment (UEs) with different clocks. Among other uses, a correct time sync is used by the nodes (gNB, IAB nodes) in a cellular network to coordinate connectivity between the UEs, gNBs, iAB Nodes and 5G packet core (EPC) and to ensure communications and operate networking functions. Time sync related errors can impact 5G/6G networking including communications (latency/drop calls, TDD), applications dependent on precise timing (location/positioning, industrial/robots/IoT), and wireless network infrastructure (beam forming, handover, aggregation). Time synchronization methods to reduce time error thereby unlock and enable new use cases requiring precise timing.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 provides an overview of network connectivity using multiple nodes and donors, according to an example.

FIGS. 2A and 2B depict network architectures corresponding to the use of IAB nodes and donors, according to examples.

FIG. 3 depicts the use of time sync reference units (TRUs) deployed in various non-terrestrial and terrestrial network arrangements, according to an example.

FIG. 4 depicts a configuration of a TRU deployed at a respective connectivity location, according to an example.

FIGS. 5A to 5F depict flowcharts of techniques for operating a TRU, according to an example.

FIG. 6 depicts a flowchart of an artificial intelligence (AI) training and inference workflow for TRU measurement collection, according to an example.

FIGS. 7 and 8 depict satellite network connectivity arrangements for a wireless access and backhaul (wAB), according to an example.

FIG. 9 depicts measurements of a timing offset problem, according to an example.

FIG. 10A depicts a network architecture in which a multi-stage TRU is used, according to an example.

FIG. 10B depicts an arrangement of a 5G network, including the use of a RU TRU to assist with UE location functionality, according to an example.

FIG. 11A depicts a flowchart of a method for implementing and operating a virtualized radio access network (vRAN) based on the time synchronization techniques, according to an example.

FIG. 11B depicts a flowchart of a method for implementing and operating network architecture in which a multi-stage TRU is used, according to an example.

FIGS. 12A, 12B, and 12C depict additional architectures for supporting vRAN and IAB configurations, according to examples.

FIG. 13 illustrates an overview of an edge cloud configuration for edge computing, according to an example.

FIG. 14 illustrates an overview of layers of distributed compute deployed among an edge computing system, according to an example.

FIG. 15 illustrates operational layers among endpoints, an edge cloud, and cloud computing environments according to an example.

FIG. 16 illustrates an example approach for networking and services in an edge computing system, according to an example.

FIG. 17A illustrates an overview of example components deployed at a compute node system, according to an example.

FIG. 17B illustrates a further overview of example components within a computing device, according to an example; and

FIG. 18 illustrates a software distribution platform to distribute software instructions and derivatives, according to an example.

### OVERVIEW

The following addresses technical challenges encountered with timing and timing use cases in 5G NR communications technologies. The following also provides approaches for enhancing and improving 5G NR communications, especially in private 5G network cells that are extended temporarily. Among other settings, private 5G network cells may be temporarily deployed to increase network capacity, including in emergency, disaster, or rapid deployment settings, at sports arenas, large cities, or at large-scale public events, or in connection with other situations that necessitate extra capacity or mobility.

The following configurations and techniques for time synchronization are applicable to a variety of wireless network settings and use cases. These use cases include UEs connected to self-backhauling wireless BSs (e.g., IAB Nodes) and temporary vRAN extensions. These use cases also include networks that perform communications using mm Wave band self-backhauling IAB Nodes, where the higher frequency transmission rates are challenged due to shorter propagation lengths and path loss susceptibility compared with lower frequencies. The use cases also include scenarios of multiple 5G cells or 5G RUs that are used for 5G UE access, including in scenarios involving a combination of wireless technologies such as Wi-Fi and 5G.

The following specifically discusses aspects of an AI-Enabled gNB, IAB, or a wAB time sync reference unit (TRU), useful for terrestrial network (TN) and non-terrestrial network (NTN) implementations of a private 5G network. As noted above, a correct time sync is used by the nodes (gNB, IAB) in a cellular network to provide connectivity between a UE, the associated RAN gNB or iAB Node, and EPC. A precise time sync is also used for precise positioning and location functions. For example, 3 ns of time sync may translate to up to 1 meter of location accuracy error. Note that the time sync error is between the UE and the RAN (gNB or iAB Node antennas), timing information on an iAB Donor Node gets sent to iAB Donors.

In an example, time adjustments and updates are provided for radio units of a 5G network. The following introduces a mechanism to calculate time sync deltas (i.e., differences) at a DU having multiple cells utilizing multiple RUs, and extensions of this mechanism to provide improvements with multiple wireless spectrum uses. In an example, this approach defines the use of TRU instances to calculate time sync deltas between RUs served by the same DU either within gNB or IAB architectures. In a multi-spectrum example, this approach uses TRU instances to calculate time sync deltas among different RUs. Each DU-RU pair supporting either a gNB or IAB donor or node is used to determine any deltas, and the deltas are averaged (e.g., weight averaged) for an offset that is made available to application adjustments. Machine learning can be used to increase the efficiency and accuracy of the calculation and position. Weighting may include one or more of: assigning higher weights to deltas with better quality or lower jitter, giving more weight to deltas from RUs that are closer to the DU as they may have more reliable timing data, using historical data to determine which RUs have consistently provided accurate timing and assigning higher weights to these RUs based on the consistency, adjusting weights based on the current load or traffic conditions of the network, prioritizing less congested paths, and considering factors such as temperature or interference, which might affect signal reliability, and adjust weights accordingly.

Various techniques may be used to calculate the differences and adjustments. For example, the precision time protocol (PTP) may be used to synchronize timing between each DU and RU pair, whereas a TRU may be used between DU and RU pairings, specifically the antennas associated with the RU that may not be co-located at the same physical location of the RU, to calculate and provide nanosecond/picosecond offset adjustments, depending on the resolution of the PTP. As will be understood, better resolution involves additional time and frequency synchronization technologies (such as synchronized ethernet (SyncE)). The timing may be further evaluated or determined using any applicable technique such as PTP, SyncE, Round Trip Time (RTT), and a calibration unit for cable delays.

The following also introduces aspects of AI data processing to enhance the determination and changes for time synchronization. Here, a machine learning model can be trained to learn patterns in RU time sync deltas, using features such as RU positions/orientations, environmental conditions, time of day/time of week variations, etc. to determine offsets for time synchronization.

In particular, the time synchronization techniques provide benefits for ephemeral vRAN deployments where communication is essential, such as in 5G private applications that utilize drones with 5G positioning that can be changed or disrupted at any time up to and including the complete loss of a cell. The AI model trained on time sync delta values can learn the anomalies in data that cause incorrect time synchronization. Adaptive corrections in the Time of Arrival data from RU's based on anomalies detected can be used to pre-emptively avoid service disruptions.

The following text provides additional context on the type of network configurations and data that can be monitored, including but not limited to the use of IAB deployments. This is followed by examples of time synchronization and associated time sync reference functionality such as provided by a TRU device. A detailed discussion of these actions and capabilities is provided after an introduction of IAB networking and connectivity.

### Overview of Integrated Access Backhaul

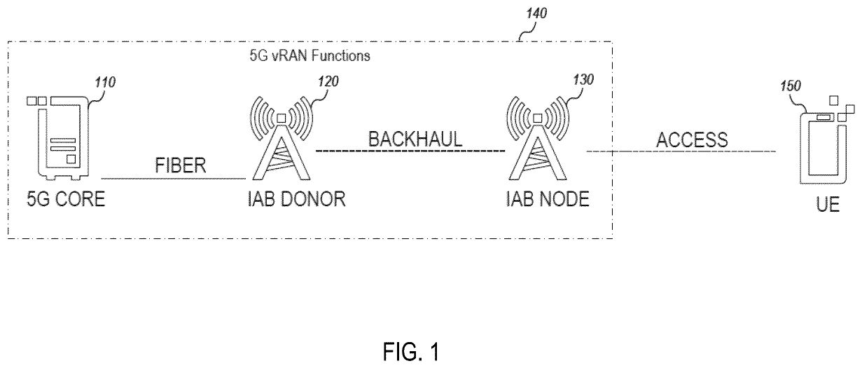

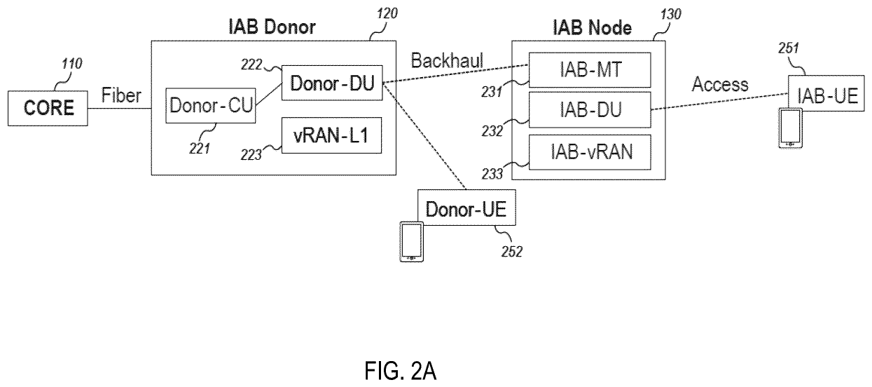

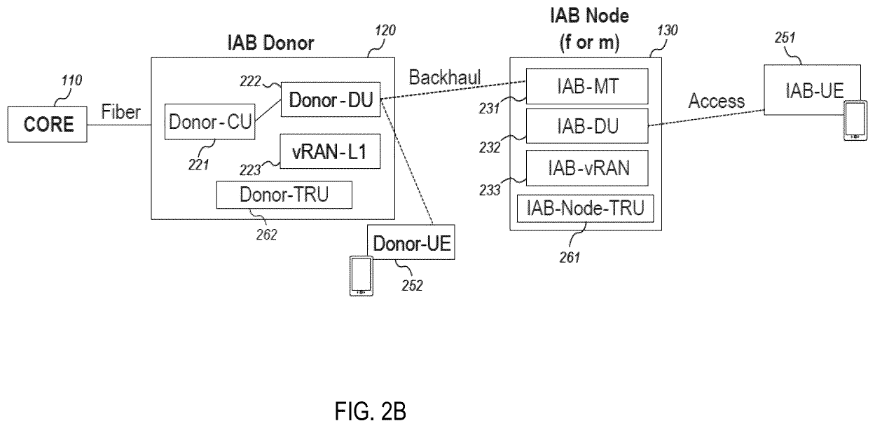

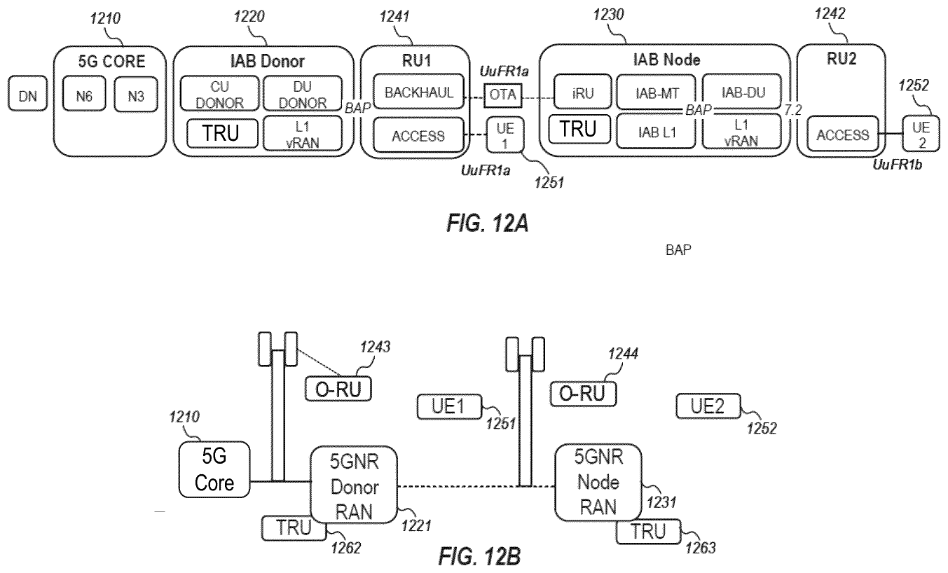

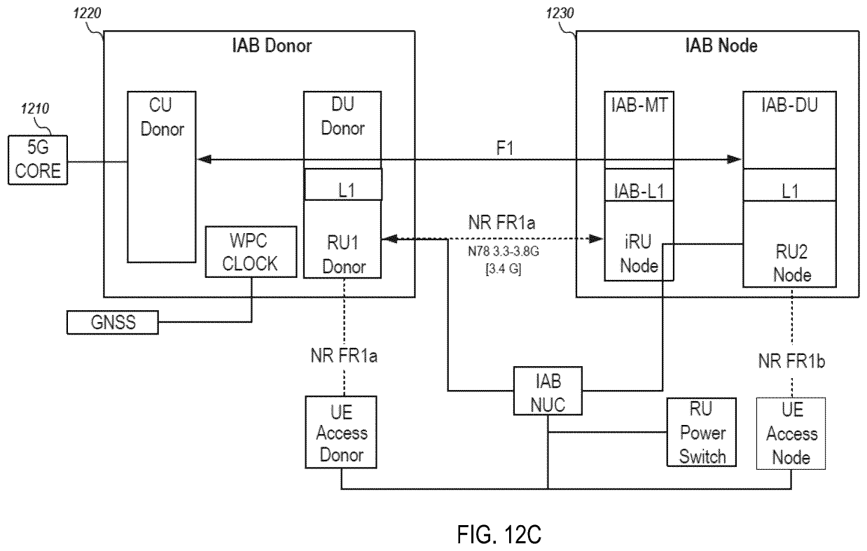

FIG. 1 provides an overview of network connectivity using IAB nodes and donors. FIG. 1 shows how a 5G Core 110 may utilize a wired link (e.g., fiber or copper network) to a IAB Donor 120, whereas the IAB Donor 120 uses a wireless backhaul to an IAB Node 130. This IAB Node 130 may be deployed at any number of locations or settings, to directly or indirectly provide access to a UE 150 (and other UEs not shown). A 5G vRAN is provided using vRAN functions 140 distributed among the 5G Core 110, the IAB Donor 120, and the IAB Node 130. The 5G Core 110, IAB Donor 120, and IAB Node 130 include respective hardware platforms and components (not depicted) for the execution of vRAN functions 140 that operate Layer 1 (L1), Layer 2 (L2), and/or Layer 3 (L3) layers via a software-based RAN stack. Additional detail on the configuration of a centralized unit (CU) and distributed unit (DU) in a vRAN is depicted with reference to FIGS. 2A to 2B, and FIGS. 12A to 12C, discussed below.

FIG. 2A depicts an architecture corresponding to the use of IAB nodes and donors. In an example, the IAB Donor 120 has a O-RAN 7.2 functional split using a CU for higher protocol tasks (e.g., authentication, etc.). The CU (e.g., Donor-CU 221), includes one or more DU(s) (e.g., Donor-DU 222) responsible for time sensitive tasks such as scheduling. The IAB Donor 120 also performs vRAN-LI functions 223 via the vRAN. One or more UEs may be directly connected to the IAB Donor 120, such as shown with Donor-UE 252.

An IAB Node 130 includes a mobile termination (MT) function, shown as IAB MT 231, which is responsible for wireless backhaul transmissions and which is connected to the Donor-DU 222. The IAB Node DU function, shown as IAB DU 232, is responsible for access transmissions to UEs such as an IAB UE 251 (and, if applicable, to provide access to other backhaul IAB Nodes that might be connected to the IAB Node 130). The IAB Node 130 also includes an IAB vRAN 233 used for performing vRAN functions at the IAB Node 130. An individual IAB Node can also operate as a parent to other IAB Nodes that are also composed of an MT and a DU.

FIG. 2B depicts a variation to the architecture of FIG. 2A. This variation shows how the IAB Node 130 provides access to the IAB UE 251, while operating a TRU identified as IAB Node-TRU 261. The IAB Donor 120 provides access to the Donor-UE 252 while operating a TRU identified as Donor-TRU 262. As discussed in the sections below, a TRU may be used to determine timing differences of radio units at the particular node, relative to other connected nodes or the 5G Core.

The evaluation of time information via a TRU (e.g., at one or both of IAB Node-TRU 261 and Donor-TRU 262, or other devices and circuitry) is discussed in the following sections. However, other network architecture variations and adaptations will also be apparent. For instance, although many of the following examples refer to IAB scenarios, other examples may be adapted to use multiple TRUs in other gNB and wAB cell scenarios.

### Time Measurements and Synchronization

The following introduces approaches for enabling time sync capabilities in a nanosecond range, via 5G mobile networking hardware. These capabilities may be provided in a variety of gNB or IAB settings, including in TN or NTN connectivity settings, and also in temporary-deployed network settings such as those used with ephemeral or mobile IAB nodes. These capabilities may also be extended for the determination of time sync information in multi-access architectures that use multiple wireless spectra.

One approach disclosed herein includes the introduction of TRU device instances (e.g., TRU circuitry) that calculate time sync deltas between RUs and the RU antennas served by the same DU either within gNB or IAB architectures. Each DU-RU pair supporting either a gNB or IAB donor or node is used to determine any deltas, and these deltas are averaged for an offset that is made available to application adjustments. This provides a technique that works with gNB, IAB, or wAB network configurations, including scenarios involving multi-spectrum or multi-function operations.

Accordingly, in some scenarios, timing may be calculated for every DU-RU pair (inclusive of multiple RUs per one DU), at every gNB, IAB node, or IAB donor. The average (e.g., weighted average) of the timing differences may be calculated to determine an appropriate time synchronization offset. This time synchronization offset can then be published and used to adjust timing at the respective nodes. Every gNB, or iAB Donor, or iAB Node has an associated time sync TRU because each gNB, iAB Donor or iAB Node has a cell that supports communication between the UE devices and that specific cell, and it is desirable for each cell to reduce the time sync error for communications and applications mentioned above. For the use of multi-spectrum networks, the time delta can also be incorporated into the determination and decision.

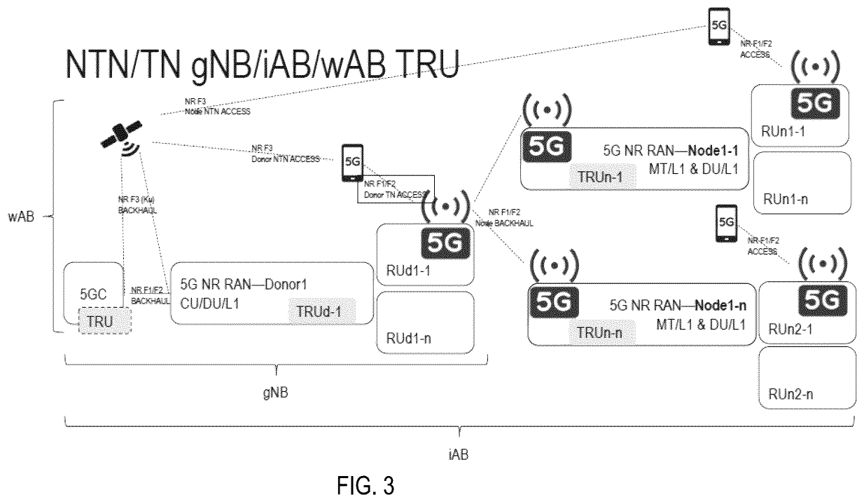

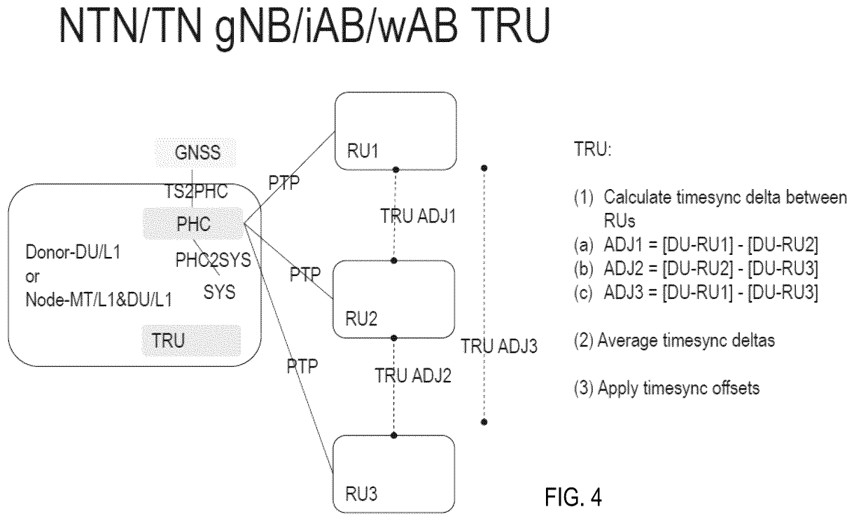

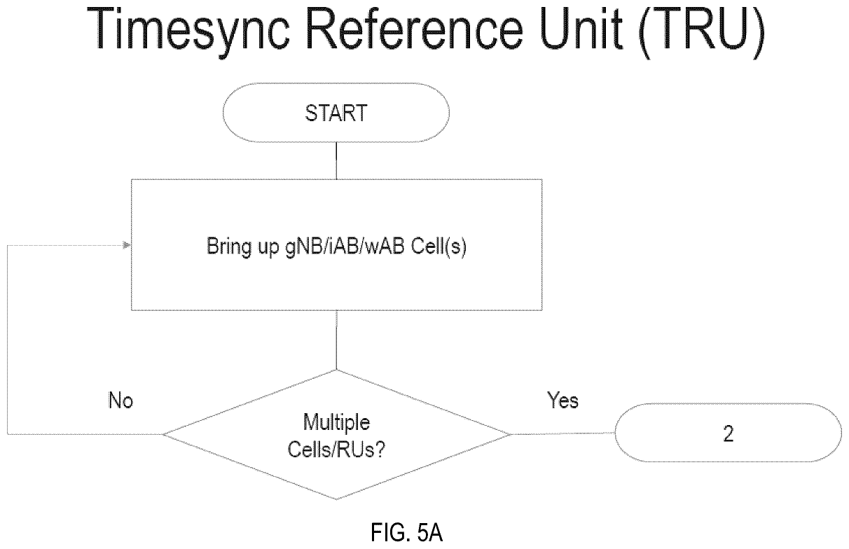

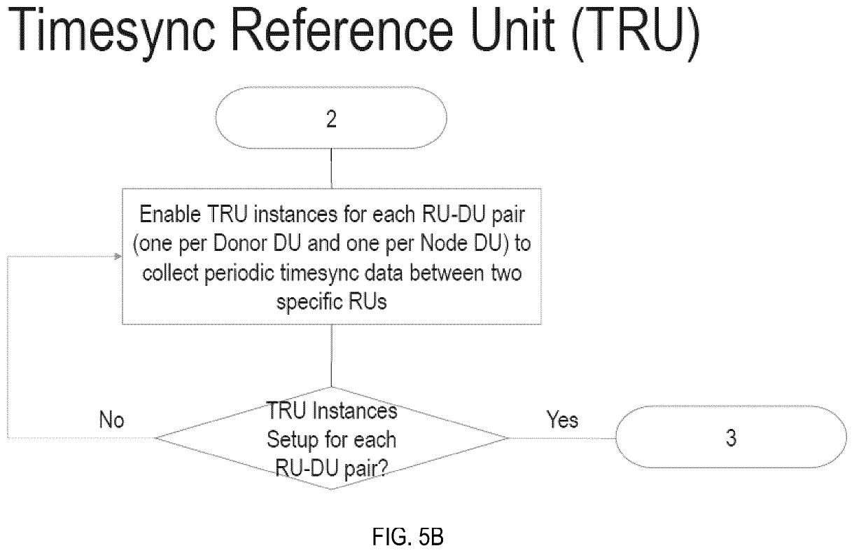

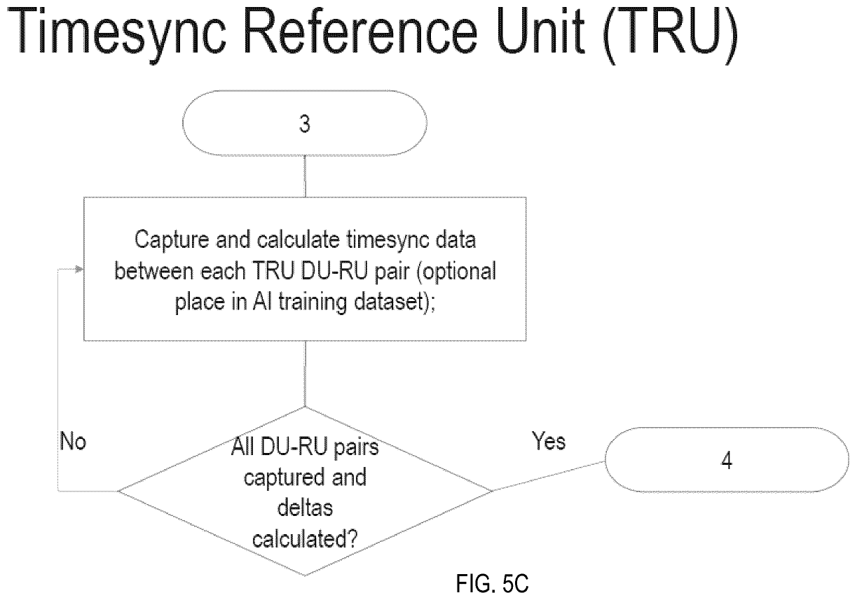

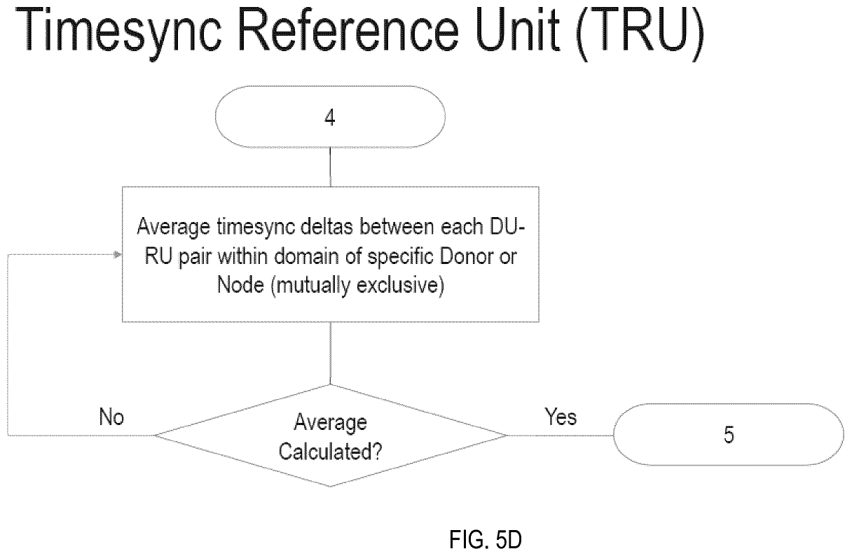

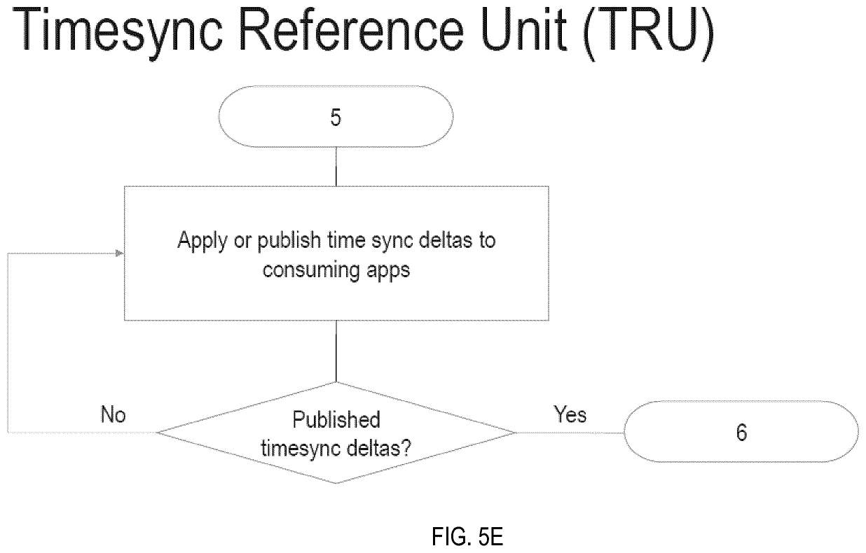

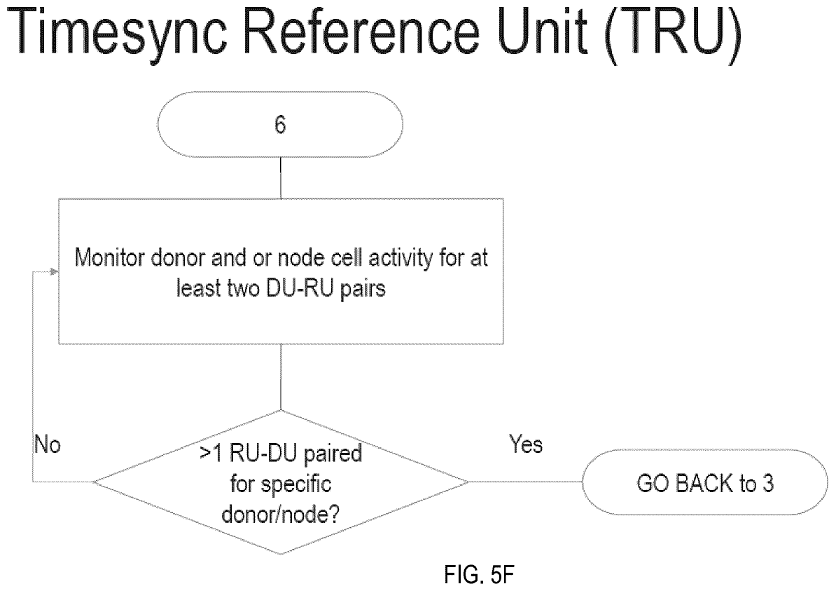

FIG. 3 depicts the use of TRUs deployed in example non-terrestrial and terrestrial network arrangements. FIG. 4 depicts a configuration of a TRU deployed at a respective connectivity location. FIGS. 5A to 5F depict flowcharts of example techniques for operating a TRU. In FIG. 5A, the TRU brings up one or more cells, which may be a gNB, iAB, or wAB and determines whether multiple cells or RUs are present. If so, in FIG. 5B TRU instances are enabled for each RU-DU pair (one per Donor DU and one per Node DU) to collect periodic time sync data between two specific RUs, continuing until TRU instances are set up for each RU-DU pair. In FIG. 5C, the time sync data between each TRU DU-RU pair is captured and calculated. This continues until all DU-RU pairs are captured and the associated deltas calculated. Optionally, the time sync data is provided in an AI training dataset. In FIG. 5D, the time sync deltas between each DU-RU pair within domain of specific Donor or Node (mutually exclusive) are averaged. In FIG. 5E, the time sync deltas are applied or published to consuming apps (e.g., location, beamforming). In FIG. 5F, the donor and or node cell activity is monitored for at least two DU-RU pairs, and, if more than one DU-RU pair is present for a specific donor/node, the process returns to FIG. 5C.

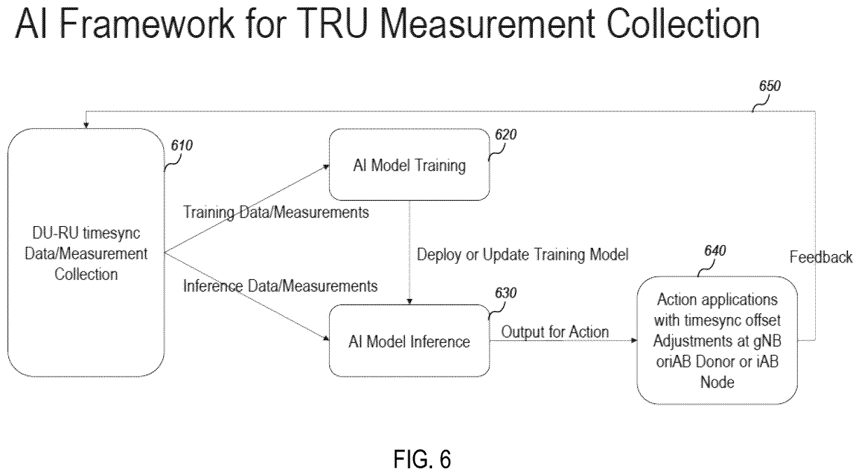

FIG. 6 depicts a flowchart of an example AI training and inference framework for TRU measurement collection. Here, this flowchart shows how DU-RU time synchronization data and measurements are collected for use in training and inference scenarios. Other sources of data and measurements may be added to training and inference operations.

Specifically, FIG. 6 depicts aspects of the collection of data and measurements used for training and learning/inferencing operations within a functional framework. At data/measurement operation 610, data and measurements are measured and collected, with the data/measurements provided as input data for training operations 620 and inference operations 630.

These measurements can be used as inputs to an AI Model (for training operations 620 or inference operations 630), or to trigger automated alerts and actions that cause adjustments in the network configuration (such as at operation 640). Feedback 650 that is collected from the performed action may also provide additional data measurements for additional training and inference. In further examples, AI model training options can include: (1) joint training between a parent IAB Donor and a child IAB Node; (2) separate training at the parent IAB Donor and a child IAB Node, where the model from each can be shared with the other; or (3) either joint or separate training with collaboration from a donor-UE and/or an access-UE and or IAB MT.

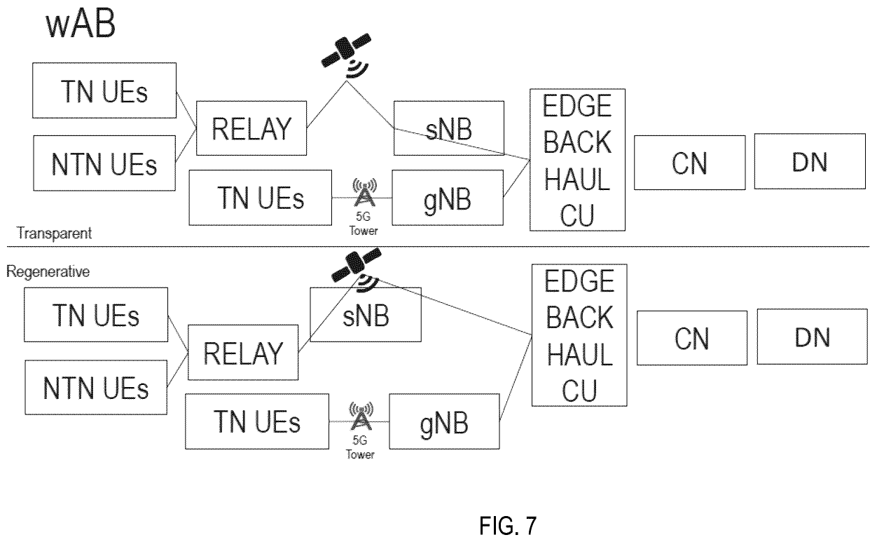

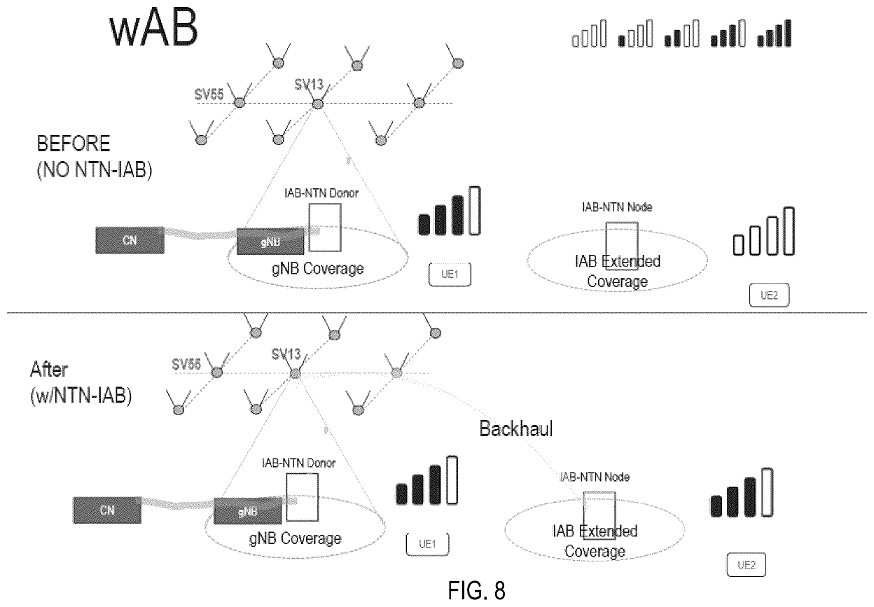

FIGS. 7 and 8 depict satellite network connectivity arrangements for a wAB, according to an example. Here, this shows connectivity settings via an NTN including with transparent and regenerative satellite NBs (sNBs), and the use of an NTN to an IAB network to provide extended coverage.

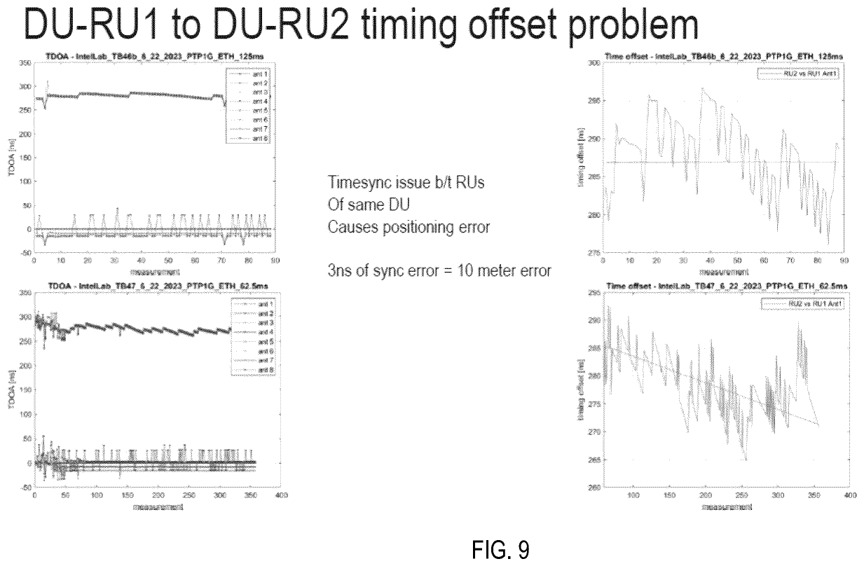

FIG. 9 depicts measurements of a timing offset problem, according to an example. The graphs shown in FIG. 9 illustrate that the time sync issues between RUs of a same DU cause positioning errors. Even a small amount of synchronization error can be significant, as 3 ns of synchronization error can lead to approximately a 1 meter error in positioning.

Precision Time Protocol (PTP) as defined in IEEE 1588 (e.g., IEEE 1588-2002, IEEE-2008, IEEE-2010) can be used to synchronize clocks of various networked computing systems. In the context of time synchronization technologies, improvements applicable to 5G location and positioning are provided. The localization algorithm used with 5G systems includes time synchronizations among gNBs and systems capable of connecting with UEs, to enable or improve triangulated location determination of respective UEs (e.g., with time distance of arrival (TDoA) calculations). If a system's time is out of sync with other systems, the TDoA may be unable to be calculated correctly, and an accurate location of the UE may be unable to be determined.

Time synchronizing intervals between RUs are established based on location periodicity used for identifying a location of a particular UE. Further, the sounding reference signal (SRS) periodicity is adjusted to the UE location periodicity to appropriately match how many times per second that an SRS will be used to find the location of the UE device. Consider an example where a system has a request to locate a UE device for 6 times per second. In this case, the DU, to find a UE location 6× per second using DR, provides an SRS uplink signal to the serving gNB plus the neighboring gNBs with a specific periodicity of around 160 ms. Each time the SRS uplink signal is sent to the gNB, calculations and measurements are used to triangulate with up to three gNBs that are in sync with one another.

However, time synchronizations performed between the gNBs may be changed based on the SRS periodicity to ensure that time synchronizations are performed often enough but not too often. For instance, a time synchronization between gNB systems can be set to a value that is just under the UE location periodicity (e.g., to 160 ms for 6× a second), so there is less traffic and thrash between the antennas that represent the gNB. If the time synchronizations are not performed often enough, UE location values may be incorrect; if the time synchronizations are performed too often, network bandwidth is wasted. With this approach, the serving and the neighboring gNBs RUs work together via a time service to handle localization requests, to evaluate periodicity, and to set the time sync interval between the SRS transmissions.

In an example, the following operations are performed to coordinate location management functions in a 3GPP location service. Operation 1: the 3GPP Location Management Function (LMF) receives a location request with a periodicity (e.g., 6 localizations per second). Operation 2: The DU sets the target UE SRS periodicity (e.g., to transmit SRS every 160 ms, thus providing a value to meet the 6 localizations per second used to determine the UE location). Operation 3: Set the syncInterval among the serving target UE cell (gNB) and any handover capable cells (e.g., that have line-of-sight and meet 3GPP transmit power thresholds) to a value that is in between the SRS transmission; for instance, this may be 125 ms (which equals a PTP G.8275.1 logSyncInterval. value of −3, i.e., 2⁻³ (0.125 seconds or 125 ms)). Operation 4: The Time sync among the gNBs is adjusted (e.g., via ptp41 or syncE) based on the syncInterval. Operation 5: The UE transmits the SRS for localization (e.g., every 160 ms). Operation 6: The RAN measurement engine calculates the ToA and sends to the LMF for TDoA, x, y, z localizations. Operation 7: Localization ends. Operation 8: Reset the syncInterval to an original non-localization value.

Accordingly, after a LMF localization request, the DU enables the SRS periodicity (e.g., 160 ms/6 times a second) for the localization periodicity. The time sync periodicity is calculated and set, using the ptp41 mechanism between the RU and the RAN once prior to SRS transmission (e.g., 125 ms) to ensure the gNBs are in sync before TOA calculations. In some examples, this approach may be implemented with use of a precise positioning PTP/SyncE profile based on a modified ITU G.8275.1 precision time protocol telecom profile.

As noted, setting the time sync interval according to localization reduces time sync traffic. Less than 1 meter of localization precision for 5G NR TDOA uses single-digit nanosecond time synchronization among gNBs either serving or in range of handover for a specific UE. TDOA relies on time sync among the gNBs to localization calculations, while TDOA does not use the time sync between the target UE and the serving gNBs.

Thus, the TRU mechanism may help reduce time synchronization-related errors that impact 5G networking including communications (e.g., latency issues, dropped calls), applications dependent on precise timing (location/positioning, industrial/robots/IoT), and wireless network infrastructure (beam forming, handover, aggregation). Time synchronization methods to reduce the effects of time error include (1) absolute time (clock synchronization); (2) frequency synchronization, (3) phase time (in which the primary clock and secondary clock pules are aligned in phase). PTP signals are used for synchronization in 5G and beyond systems; PTP signals carry the timestamp request/response to measure and sync up timing. The PTP signals set the DU system clock and are supplied to the RUs. The GNSS accuracy is about 5 ns in time synchronization.

The TRU is used in conjunction with PTP/SyncE mechanisms to improve time sync and reduce time synchronization error by calibrating and adjusting for cable and environment delays automatically in real-time. This may be problematic, especially in a private network with different cables attached to different antennas and different path losses and interferences. For example, inside of a large commercial building (e.g., factory), antennas may be attached to ceiling corners of the building; 5G signals are used inside as GNSS signals are too weak and jammable. To enable location determination, the private network uses at least 3 antennas capable of a round trip SRS request/response to meet the overall location measurement periodicity and accuracy for a moving target UE. Beamforming may use a similar approach, especially as the target UE is moving.

The TRU may be static for calibration purposes, having a known location and known antenna placement for each antenna supplying TOAs to the TDoA location algorithm. Once the TRU is positioned, the measurements may be performed in real-time at the same periodicity for each target UE. In addition, the real-time calibration (offset) is sent along with the uncalibrated TOAs for each antenna for each individual target UE. The uncalibrated TOAs are adjusted using the offset before the particular application (e.g., location or beam forming) performs the associated function and the results are sent to a requestor (e.g., 911 operator or factory supervisor, for beam forming). The TRU may be located in the DU as shown previously, or may be split into different devices with different functionalities.

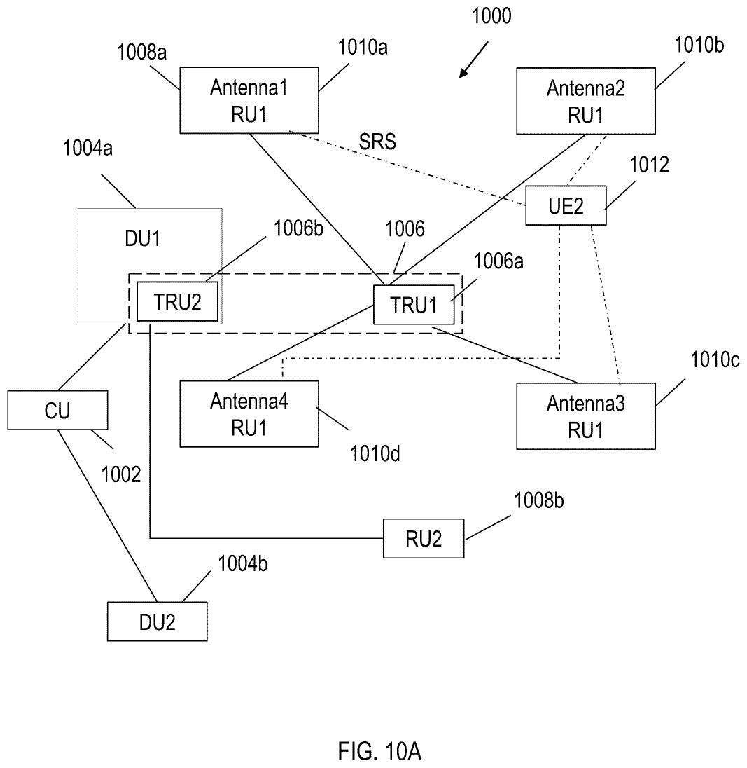

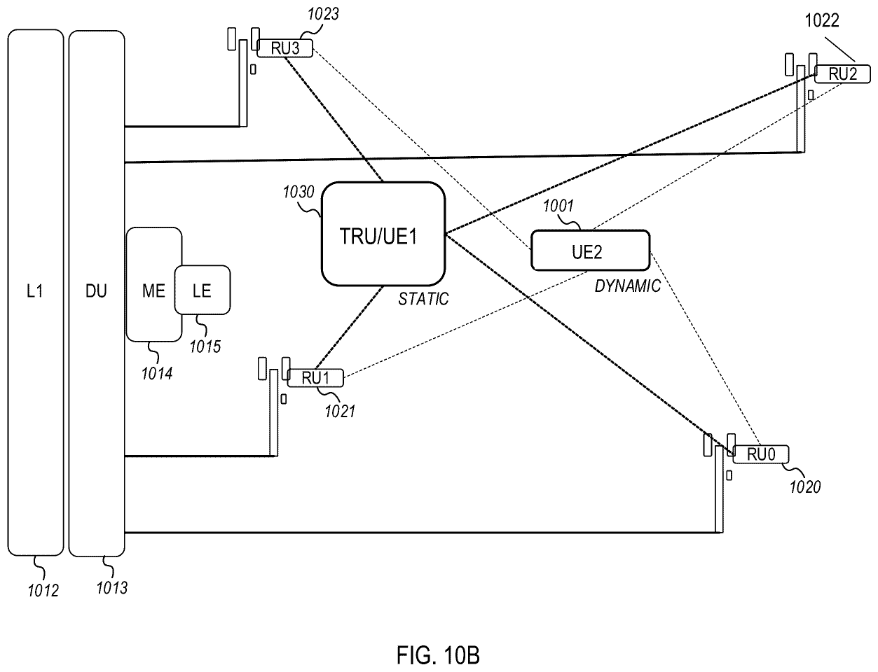

FIG. 10A depicts a network architecture in which a multi-stage TRU is used, according to an example. The architecture 1000 includes a CU 1002 and multiple DUs 1004a, 1004b associated with the CU 1002. Each DU 1004a, 1004b may be coupled to one or more RUs 1008a, 1008b. Each RU 1008a, 1008b may be coupled to one or more antennas 1010a, 1010b, 1010c, 1010d in a fixed known location (RU1 1008a is shown as having four antennas, although any number greater than three may be used). Each DU 1004a, 1004b is associated with a different TRU 1006. The TRU 1006 may be split into two parts: TRU1 1006a may be a physical device, such as a UE, with a known position geographically located in the area within the boundary of the overall 5G positioning field of interest area; TRU2 1006b may be a software component located on a DU server (DU1 1004a) as a microservice responsible for measuring and calculating the offsets to be applied to raw TOAs.

For a private 5G network setting, in some embodiments a single primary DU-RU pairing may be used and maintain the 3GPP scheduling associations with the TRU1 1006a and the other target UE devices to be positioned. In this case, the TRU2 1006b may consume SRS responses from the known location of TRU1 1006a for each antenna 1010a, 1010b, 1010c, 1010d time of arrival (TOA). At least three TOAs are used to calculate the physical location of the TRU1 1006a using a time difference of arrival (TDoA) algorithm. In this case, the TRU2 1006b calculates the offsets for each antenna 1010a, 1010b, 1010c, 1010d TOA and may provide this to a TDoA location engine to provide the position of the TRU1 1006a as indicated by predetermined tolerances (for example within 1 meter).

In practice, one of the antennas may be used to determine ground truth information, from which the offsets of the other antennas are measured and corrected. TRU2 1006b uses offset data of the TRU1 1006a to calibrate and compensate for cable and environmental losses between each antenna 1010a, 1010b, 1010c, 1010d. Each antenna 1010a, 1010b, 1010c, 1010d may have a different time offset (calibration value). The time offsets may be sent in parallel with the TOAs to the TDoA location engine, which adjusts the particular TOA using the appropriate calibration value before the TDoA location engine calculates the position. The cable loss factor may be stable, but the path loss environmental factors may change so if the TRU1 1006a experiences path loss, that path loss is reflected in the TRU2 1006b calibrations. Multiple DU-RU pairs of the same DU may be used for coverage within a predetermined area (e.g., a factory or other commercial area), with the RUs being in sync to provide accurate location determination.

In some embodiments, to maintain the time synchronization of the TRU1 1006a and other UEs in the sensing environment (e.g., factory), PTP signals are used between the DU1 1004a and RU1 1008a (and RU2 1008b). The periodicity of the PTP signals matches or is close to (e.g., within a few ms of) that of the positioning periodicity (e.g., 8 position calculations per second=once every 125 ms, or 6 position calculations per second=once every 167 ms). That is, the PTP signals may be transmitted from the DUI 1004a to the RU1 1008a close in time to the SRS transmissions from the antenna 1010a, 1010b, 1010c, 1010d to the RU1 1008a so that the offsets are able to be calculated close in time to the SRS transmissions.

Calibration signals from the antenna 1010a, 1010b, 1010c, 1010d may be received at the TRU1 1006a and may be transmitted to the TRU2 1006b to determine the offset. After the offset is determined for each antenna 1010a, 1010b, 1010c, 1010d, the offsets may be applied to the ToA values for SRS signals from a target UE (UE2 1012) received from the antennas 1010a, 1010b, 1010c, 1010d and the location or appropriate beamforming characteristics determined appropriately. The calculations may be performed by the TRU1 1006a, the TRU2 1006b, and/or a network entity (e.g., a location management server)-in the last case, the offsets and ToA values may be sent at the same time from the TRU2 1006b to the network entity. After application of the offset the location of the UE2 1012 may be determined based on TDoA. In some cases, multiple RUs coupled to the DU may be used within the same environment, each having at least three antennas. The offsets may be determined using the same stationary UE/TRU1 or different UEs and may be averaged as above.

In some embodiments, TRU2 1006b may contain inputs in which ptp41 is an implementation of the PTP; ts2phc synchronizes PTP Hardware Clocks (PHC) to external time stamp signals; phc2sys synchronizes two or more clocks in the system, typically used to synchronize the system clock to a PHC; and pmc implements a PTP management client according to IEEE standard 1588.

FIG. 10B depicts an arrangement of a 5G network, including the use of a RU TRU (calibrator) to assist with UE location functionality, according to an example. In the arrangement, an assumption is made that a clock leader (e.g., grandmaster) distributes synchronized time to all RUs, so all RU jitter is the same. If the relative time sync between all RUs is less than 1 nanosecond (ns), then all RUs experience the same time drift. In FIG. 10B, the TRU 1030 is operated as a UE at a static location, and is positioned relative to RU0 1020, RU1 1021, RU2 1022, RU3 1023. Here, a UE 1001 is operated at a dynamic (changing) location, while receiving connectivity from RUs RU0 1020, RU1 1021, RU2 1022, RU3 1023. The specific functions of the Node including a Layer1 (L1) 1012, DU 1013, measurement engine (ME) 1014, and location engine (LE) 1015 are depicted. Note that a TRU may be limited to locations in which a RAN RU-DU/antennas cell is present, in which a cell is a 5G NR cell that connects UE devices to the 5GC.

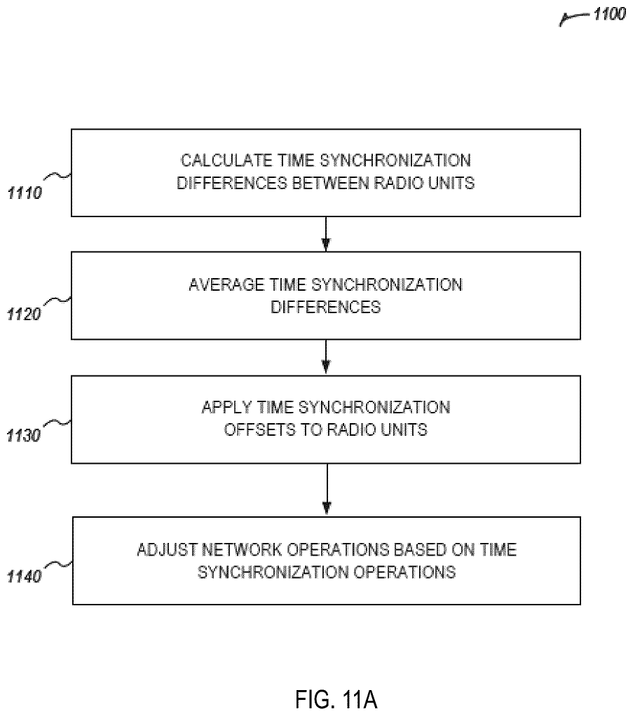

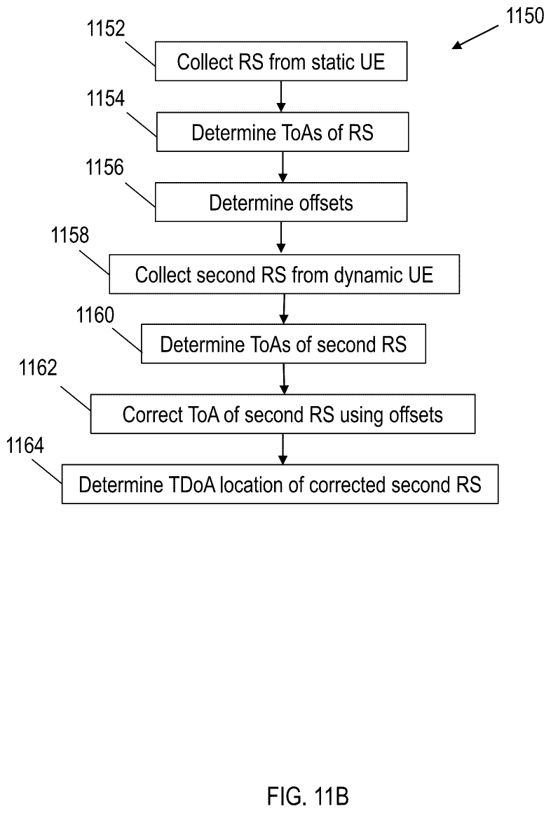

A gNB or IAB architecture may be used for implementing a time sync reference unit, according to an example. In some embodiments, the electronic device(s), network(s), system(s), chip(s) or component(s), or portions or implementations thereof, of the figures herein may be configured to perform one or more processes, techniques, or methods as described herein, or portions thereof. One such process is depicted in FIG. 11A, which depicts a flowchart 1100 of an example method for implementing and operating a vRAN further to the time synchronization techniques discussed above. FIG. 11A may be performed by any element described herein, such as in the CN. For example, the flowchart 1100 may include, at operation 1110, calculation of time synchronization differences between radio units. At operation 1120, the time synchronization differences may be averaged. At operation 1130, time synchronization offsets may be applied to the radio units. At operation 1140, network operations may be adjusted based on the time synchronization operations.

Another such process is depicted in FIG. 11B, which depicts a flowchart 1150 of a method for implementing and operating network architecture in which a multi-stage TRU is used, according to an example. FIG. 11B may be performed by any one or more elements described herein.

At operation 1152, first reference signals are collected at a TRU. The first reference signals are transmitted from a stationary UE and received by each of a plurality of antennas associated with a first RU coupled to a DU.

At operation 1154, a time of arrival of the first reference signals at each of the plurality of antennas is determined.

At operation 1156, a timing offset is determined for each of the plurality of antennas based on the first reference signals, a known location of the stationary UE and known locations of the plurality of antennas.

At operation 1158, second reference signals transmitted from a dynamic UE and received by each of the plurality of antennas are collected, the first and second reference signals having a same or near same periodicity and synchronized to PTP signals received the RU.

At operation 1160, a time of arrival of the second reference signals at each of the plurality of antennas is determined.

At operation 1162, for each of the plurality of antennas, the time of arrival of the reference signal at the antenna is corrected based on the timing offset corresponding to the antenna.

At operation 1164, a location of the dynamic UE or other application is performed based on a time difference of arrival based on the time of arrival and the timing offset at the plurality of antennas.

### Additional vRAN and IAB Configurations

FIGS. 12A, 12B, and 12C depict additional architectures for supporting vRAN and IAB configurations, according to various examples. First, FIG. 12A provides more details on radio access and interfaces used in a 5G network with IAB. As discussed in 3GPP TS 23.501, IAB approaches enable wireless in-band and out-of-band relaying of NR Uu access traffic via NR Uu backhaul links. The Uu backhaul links can exist between an IAB node (shown as IAB Node 1230) and a gNB in an IAB Donor (shown as IAB Donor 1220), which itself may be another IAB Node.

The IAB node that supports the Uu interface toward the IAB Donor or another parent IAB Node is referred to in the 3GPP TS as an IAB UE. In some examples, the IAB may reuse the CU/DU architecture defined in TS 38.401. The IAB operations via F1 (e.g., between IAB Donor 1220 and IAB Node 1230) may not be visible to the 5G Core 1210. The IAB performs relaying at layer 2, and therefore might not use a local user plane function (UPF). The IAB also supports multi-hop backhauling. Other 3GPP IAB reference architectures (not shown) may include multiple (e.g., two) backhaul hops when connected to the 5G Core 1210.

Thus, an IAB architecture for 5G systems has an gNB-DU in the IAB node that is responsible for providing NR Uu access to UEs (e.g., UE 1252) and child IAB nodes (e.g., via RU2 1242). The corresponding gNB-CU function resides on the IAB Donor gNB 1220, which controls IAB Node 1230 gNB-DU via the F1 interface (e.g., provided by RU1 1241, which also provides NR Uu access to UEs such as UE 1251). An IAB Node appears as a normal gNB to UEs and other IAB nodes and allows the UEs and other IAB nodes to connect to the 5G Core 1210. Thus, the IAB UE function behaves as a UE, and reuses UE procedures to connect to the gNB-DU on a parent IAB node or IAB donor for access and backhauling; and to connect the gNB-CU on the IAB donor via radio resource control (RRC) for control of the access and backhaul link.

FIG. 12B depicts a donor-node network arrangement, including the use of multiple TRUs as discussed herein. Here, a 5GNR Donor RAN 1221 uses an O-RU 1243 to provide access to a UE1 1251, and a 5GNR Node RAN uses an O-RU 1244 to provide access to a UE2 1252. The 5GNR Node RAN 1231 connects to the 5GNR Donor RAN 1221 via a backhaul (e.g., IAB), and the 5GNR Donor RAN 1221 connects to the 5G Core 1210 via a wired/fiber connection. Meanwhile, a TRU 1262, 1263 is located at the 5G Core 1210, the 5GNR Donor RAN 1221, and the 5GNR Node RAN 1231, respectively, to determine timing information and time synchronization changes applicable throughout the 5G network.

Finally, FIG. 12C depicts a further architecture of a donor-node network arrangement, which may collect data and provide network connectivity using IAB as discussed above. As above, the IAB Donor 1220 provides connectivity and control to the IAB Node 1230, via F1 and NR FR1a interfaces. In specific examples, the data collected for AI model training (e.g., for training of an AI model used for network interference measurement and detection, and/or analysis of network reference measurements) can include: (1) joint training on data between a parent IAB Donor and a child IAB Node; (2) separate training on data from the parent IAB Donor and a child IAB Node, with the model used at one location being shared with the other location; or (3) either joint or separate training, using collaboration of data from a donor-UE and or an access-UE and or IAB MT. Other measurements and training may occur in connection with the AI-driven data collection and analysis for time sync offset adjustments.

In some embodiments, there here are 2 stages and 2 separate AI learning opportunities: pre-cell bring up and calibration and cell up with TRU. Pre-cell bring up occurs at every cell to perform the initial TRU calibration. The locations of the UE and all antennas connected to the RU are known. In this case, the AI model may be used to help guide the initial settings but those settings must converge to yield the precise location of the physical TRU device. The calibrations between the RU and each antenna are “fixed” in that the RU antennas do not change. In cell up with TRU, the initial TRU calibrations are used to seed the TRU output of relative offsets. Every time a target UE TOA is determined there is a matching TRU TOA calculation, if the TRU TOA calculation does not give the known location of the TRU UE then the individual offsets are adjusted such that each offset yields the exact location of the known TRU location s and those offsets are used with the Target TOA values to mitigate and fix the time error. For example, if the location of the TRU is known (e.g., 3, 3, 3) and the TRU TOAs (4 values from each antenna) are determined, the output of the LMF TDOA calculation is known. If the LMF TDOA calculation =3, 3, 3 for the TRU then all offsets are ZERO (0,0,0,0), otherwise the offset is adjusted for each antenna so the LMF TDO converges onto 3, 3, 3 [within the given timeframe for the calculation for example every 120 ms], if not the offset is discarded as it does not arrive in time. In some embodiments, placement of the TRU may be in the center of the environment (e.g., factory floor), i.e., 3, 3, 3.

### Implementation in Edge Computing Scenarios

It will be understood that the present communication and networking arrangements may be implemented with many aspects of edge computing strategies and deployments. Edge computing, at a general level, refers to the transition of compute and storage resources closer to endpoint devices (e.g., consumer computing devices, user equipment, etc.) to optimize total cost of ownership, reduce application latency, improve service capabilities, and improve compliance with security or data privacy requirements. Edge computing may, in some scenarios, provide a cloud-like distributed service that offers orchestration and management for applications among many types of storage and compute resources. As a result, some implementations of edge computing have been referred to as the “edge cloud” or the “fog”, as powerful computing resources previously available only in large remote data centers are moved closer to endpoints and made available for use by consumers at the “edge” of the network.

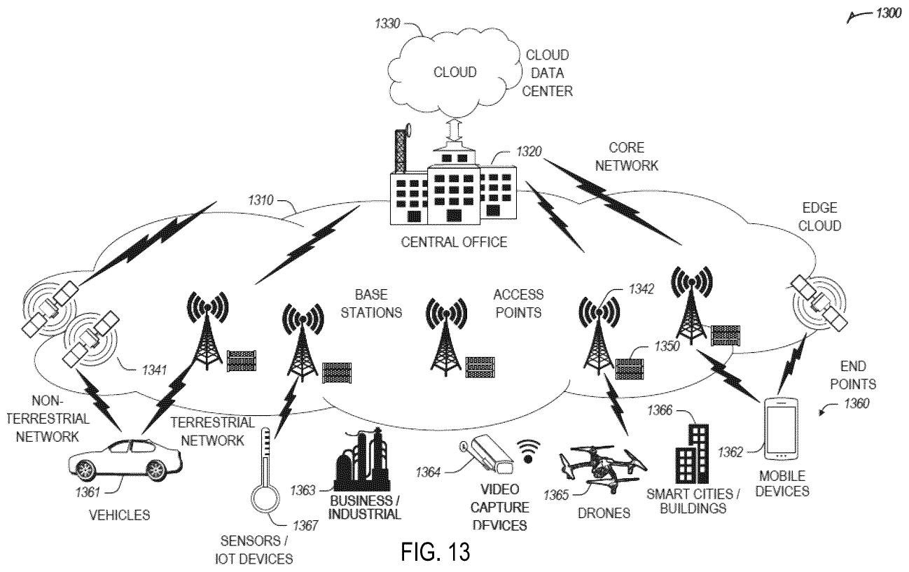

FIG. 13 is a block diagram 1300 showing an overview of a configuration for edge computing, which includes a layer of processing referenced in many of the current examples as an “edge cloud”. This network topology, which may include a number of conventional networking layers (including those not shown herein), may be extended through use of the satellite and non-terrestrial network communication arrangements discussed herein.

As shown, the edge cloud 1310 is co-located at an edge location, such as a satellite vehicle 1341, a base station 1342, a local processing hub 1350, or a central office 1320, and thus may include multiple entities, devices, and equipment instances. The edge cloud 1310 is located much closer to the endpoint (consumer and producer) data sources 1360 (e.g., autonomous vehicles 1361, user equipment 1362, business and industrial equipment 1363, video capture devices 1364, drones 1365, smart cities and building devices 1366, sensors and IoT devices 1367, etc.) than the cloud data center 1330. Compute, memory, and storage resources which are offered at the edges in the edge cloud 1310 are critical to providing ultra-low or improved latency response times for services and functions used by the endpoint data sources 1360 as well as reduce network backhaul traffic from the edge cloud 1310 toward cloud data center 1330 thus improving energy consumption and overall network usages among other benefits.

Compute, memory, and storage are scarce resources, and generally decrease depending on the edge location (e.g., fewer processing resources being available at consumer end point devices than at a base station or at a central office). However, the closer that the edge location is to the endpoint (e.g., UEs), the more that space and power is constrained. Thus, edge computing, as a general design principle, attempts to minimize the amount of resources needed for network services, through the distribution of more resources which are located closer both geographically and in network access time.

In an example, an edge cloud architecture extends beyond typical deployment limitations to address restrictions that some network operators or service providers may have in their own infrastructures. These include, variation of configurations based on the edge location (because edges at a base station level, for instance, may have more constrained performance); configurations based on the type of compute, memory, storage, fabric, acceleration, or like resources available to edge locations, tiers of locations, or groups of locations; the service, security, and management and orchestration capabilities; and related objectives to achieve usability and performance of end services.

Edge computing is a developing paradigm where computing is performed at or closer to the “edge” of a network, typically through the use of a compute platform implemented at base stations, gateways, network routers, or other devices which are much closer to end point devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with compute hardware that performs virtualized network functions and offers compute resources for the execution of services and consumer functions for connected devices. Likewise, within edge computing deployments, there may be scenarios in services which the compute resource may be “moved” to the data, as well as scenarios in which the data may be “moved” to the compute resource. Or as an example, base station (or satellite vehicle) compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

In contrast to the network architecture of FIG. 13, traditional endpoint (e.g., UE, vehicle-to-vehicle (V2V), vehicle-to-everything (V2X), etc.) applications are reliant on local device or remote cloud data storage and processing to exchange and coordinate information. A cloud data arrangement allows for long-term data collection and storage, but may not be optimal for highly time varying data, such as a collision, traffic light change, etc. and may fail in attempting to meet latency challenges. Depending on the real-time needs of a communications context, a hierarchical structure of data processing and storage nodes may be defined in an edge computing deployment. For example, such a deployment may include local ultra-low-latency processing, regional storage and processing as well as remote cloud data center based storage and processing. Key performance indicators (KPIs) may be used to identify where sensor data is appropriately transferred and where it is processed or stored. This typically depends on the ISO layer dependency of the data. For example, lower layer (PHY, MAC, routing, etc.) data typically changes quickly and is better handled locally in order to meet latency requirements. Higher layer data such as Application Layer data is typically less time critical and may be stored and processed in a remote cloud data center.

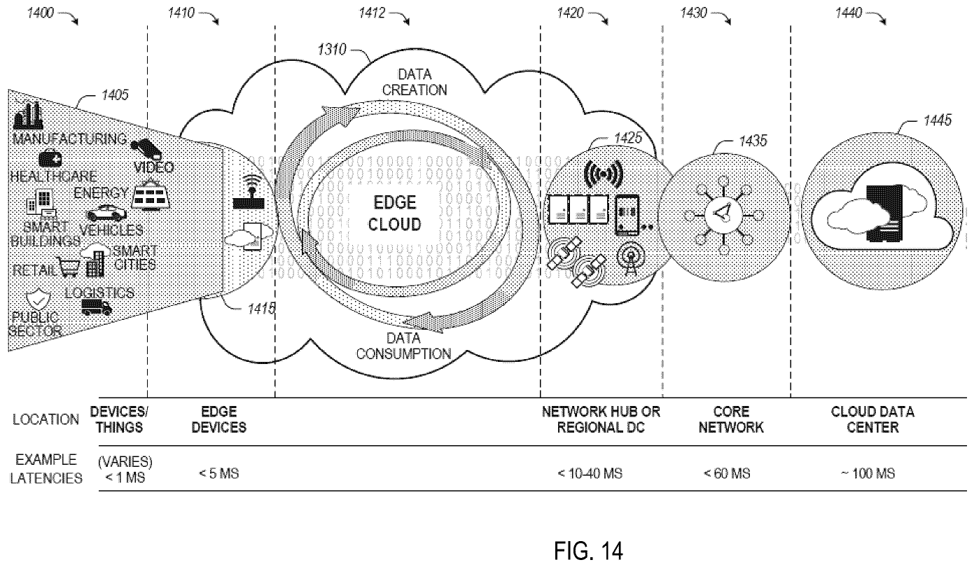

FIG. 14 illustrates operational layers among endpoints, an edge cloud, and cloud computing environments. Specifically, FIG. 14 depicts examples of computational use cases 1405, utilizing the edge cloud 1310 among multiple illustrative layers of network computing. The layers begin at an endpoint (devices and things) layer 1400, which accesses the edge cloud 1310 to conduct data creation, analysis, and data consumption activities. The edge cloud 1310 may span multiple network layers, such as an edge devices layer 1410 having gateways, on-premise servers, or network equipment (nodes 1415) located in physically proximate edge systems; a network access layer 1420, encompassing base stations, radio processing units, network hubs, regional data centers (DC), or local network equipment (equipment 1425); and any equipment, devices, or nodes located therebetween (in layer 1412, not illustrated in detail). The network communications within the edge cloud 1310 and among the various layers may occur via any number of wired or wireless mediums, including via connectivity architectures and technologies not depicted.

Examples of latency with terrestrial networks, resulting from network communication distance and processing time constraints, may range from less than a millisecond (ms) when among the endpoint layer 1400, under 5 ms at the edge devices layer 1410, to even between 10 to 40 ms when communicating with nodes at the network access layer 1420. (Variation to these latencies is expected with use of non-terrestrial networks). Beyond the edge cloud 1310 are core network and cloud data center layers 1430 and 1440, with increasing latency (e.g., between 50-60 ms at the core network layer 1430, to 100 or more ms at the cloud data center layer). As a result, operations at a core network data center 1435 or a cloud data center 1445, with latencies of at least 50 to 100 ms or more, will not be able to accomplish many time-critical functions of the use cases 1405. These latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 1435 or a cloud data center 1445, a central office or content data network may be considered as being located within a “near edge” layer (“near” to the cloud, having high latency values when communicating with the devices and endpoints of the use cases 1405), whereas an access point, base station, on-premise server, or network gateway may be considered as located within a “far edge” layer (“far” from the cloud, having low latency values when communicating with the devices and endpoints of the use cases 1405). It will be understood that other categorizations of a particular network layer as constituting a “close”, “local”, “near”, “middle”, or “far” edge may be based on latency, distance, number of network hops, or other measurable characteristics, as measured from a source in any of the network layers 1400-1440.

The various use cases 1405 may access resources under usage pressure from incoming streams, due to multiple services utilizing the edge cloud. To achieve results with low latency, the services executed within the edge cloud 1310 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at respective layers in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement operations to remediate.

Thus, with these variations and service features in mind, edge computing within the edge cloud 1310 may provide the ability to serve and respond to multiple applications of the use cases 1405 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), etc.), which might not leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power uses greater memory bandwidth. Likewise, improved security of hardware and root of trust trusted functions are also implicated, because edge locations may be unmanned and may even need permissioned access (e.g., when housed in a third-party location). Such issues are magnified in the edge cloud 1310 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 1310 (network layers 1400-1440), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), communication services provider (CoSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, circuitry, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 1310.

As such, the edge cloud 1310 is formed from network components and functional features operated by and within edge gateway nodes, edge aggregation nodes, or other edge compute nodes among network layers 1410-1430. The edge cloud 1310 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 1310 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

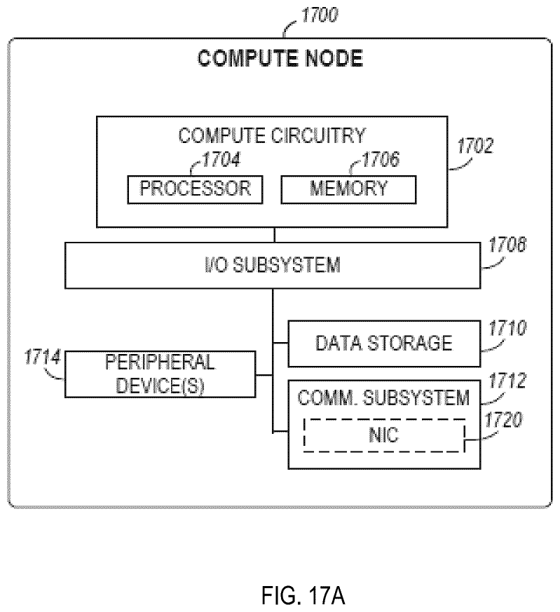

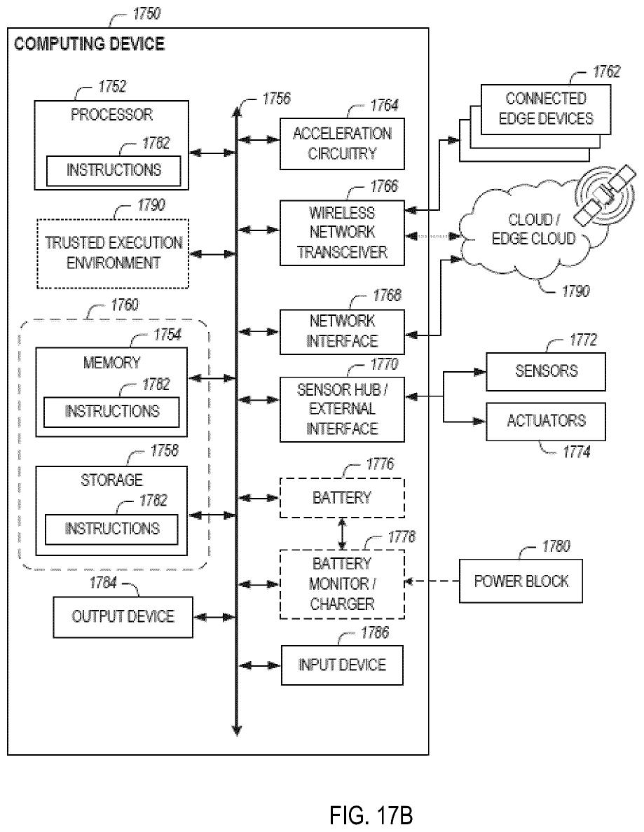

The network components of the edge cloud 1310 may be servers, multi-tenant servers, appliance computing devices, and/or any other type of computing devices. For example, a node of the edge cloud 1310 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 17B. The edge cloud 1310 may also include one or more servers and/or one or more multi-tenant servers. Such a server may include an operating system and implement a virtual computing environment. A virtual computing environment may include a hypervisor managing (e.g., spawning, deploying, shutting down, etc.) one or more virtual machines, one or more containers, etc. Such virtual computing environments provide an execution environment in which one or more applications and/or other software, code or scripts may execute while being isolated from one or more other applications, software, code or scripts.

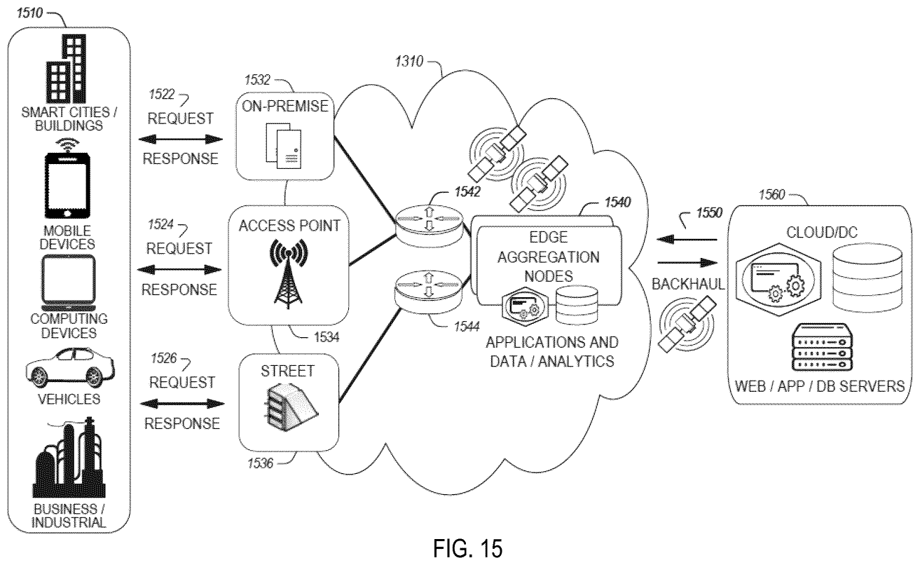

In FIG. 15, various client endpoints 1510 (in the form of mobile devices, computers, autonomous vehicles, business computing equipment, industrial processing equipment) exchange requests and responses that are specific to the type of endpoint network aggregation. For instance, client endpoints 1510 may obtain network access via a wired broadband network, by exchanging requests and responses 1522 through an on-premise network system 1532. Some client endpoints 1510, such as mobile computing devices, may obtain network access via a wireless broadband network, by exchanging requests and responses 1524 through an access point (e.g., cellular network tower) 1534. Some client endpoints 1510, such as autonomous vehicles may obtain network access for requests and responses 1526 via a wireless vehicular network through a street-located network system 1536. However, regardless of the type of network access, the TSP may deploy aggregation points 1542, 1544 within the edge cloud 1310 to aggregate traffic and requests. Thus, within the edge cloud 1310, the TSP may deploy various compute and storage resources, such as at edge aggregation nodes 1540 (including those located at satellite vehicles), to provide requested content. The edge aggregation nodes 1540 and other systems of the edge cloud 1310 are connected to a cloud or data center 1560, which uses a backhaul network 1550 (such as a satellite backhaul) to fulfill higher-latency requests from a cloud/data center for websites, applications, database servers, etc. Additional or consolidated instances of the edge aggregation nodes 1540 and the aggregation points 1542, 1544, including those deployed on a single server framework, may also be present within the edge cloud 1310 or other areas of the TSP infrastructure.

At a more generic level, an edge computing system may be described to encompass any number of deployments operating in the edge cloud 1310, which provide coordination from client and distributed computing devices. FIG. 14 provides a further abstracted overview of layers of distributed compute deployed among an edge computing environment for purposes of illustration.

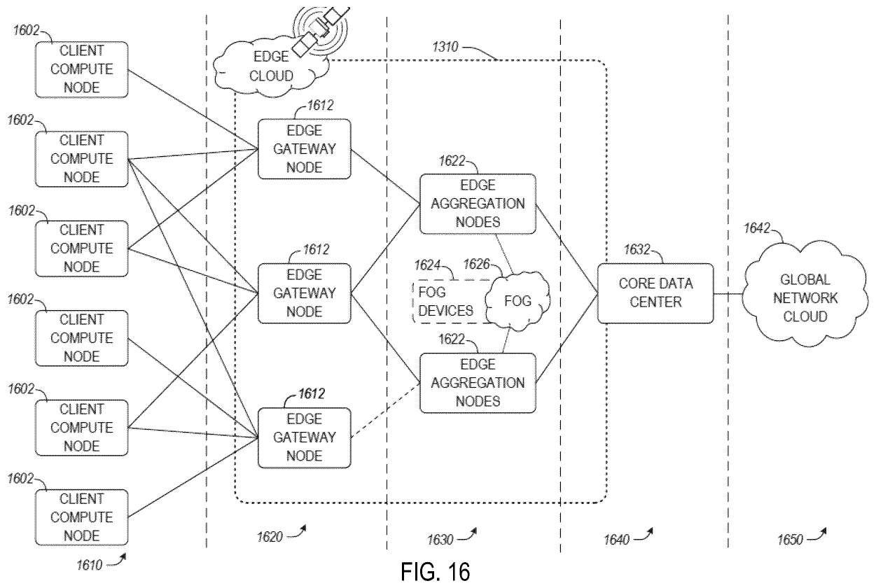

FIG. 16 generically depicts an edge computing system for providing edge services and applications to multi-stakeholder entities, as distributed among one or more client compute nodes 1602, one or more edge gateway nodes 1612, one or more edge aggregation nodes 1622, one or more core data centers 1632, and a global network cloud 1642, as distributed across layers of the network. The implementation of the edge computing system may be provided at or on behalf of a telecommunication service provider (“telco”, or “TSP”), internet-of-things service provider, cloud service provider (CSP), enterprise entity, or any other number of entities.

A respective node or device of the edge computing system is located at a particular layer corresponding to layers 1400, 1410, 1420, 1430, 1440. For example, the client compute nodes 1602 are located at an endpoint layer 1400, while the edge gateway nodes 1612 are located at an edge devices layer 1410 (local level) of the edge computing system. Additionally, the edge aggregation nodes 1622 (and/or fog devices 1624, if arranged or operated with or among a fog networking configuration 1626) are located at a network access layer 1420 (an intermediate level). Fog computing (or “fogging”) generally refers to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein are applicable to fog networks, fogging, and fog configurations. Further, aspects of the edge computing systems discussed herein may be configured as a fog, or aspects of a fog may be integrated into an edge computing architecture.

The core data center 1632 is located at a core network layer 1430 (e.g., a regional or geographically-central level), while the global network cloud 1642 is located at a cloud data center layer 1440 (e.g., a national or global layer). The use of “core” is provided as a term for a centralized network location—deeper in the network—which is accessible by multiple edge nodes or components; however, a “core” does not necessarily designate the “center” or the deepest location of the network. Accordingly, the core data center 1632 may be located within, at, or near the edge cloud 1310.

Although an illustrative number of client compute nodes 1602, edge gateway nodes 1612, edge aggregation nodes 1622, core data centers 1632, global network clouds 1642 are shown in FIG. 16, it should be appreciated that the edge computing system may include more or fewer devices or systems at respective layers. Additionally, as shown in FIG. 16, the number of components of the layers 1400, 1410, 1420, 1430, 1440 generally increases at respective lower levels (e.g., when moving closer to endpoints). As such, one edge gateway node 1612 may service multiple client compute nodes 1602, and one edge aggregation node 1622 may service multiple edge gateway nodes 1612.

Consistent with the examples provided herein, a client compute node 1602 may be embodied as any type of end point component, device, appliance, or “thing” capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 1310.

As such, the edge cloud 1310 is formed from network components and functional features operated by and within the edge gateway nodes 1612 and the edge aggregation nodes 1622 of layers 1420, 1430, respectively. The edge cloud 1310 may be embodied as any type of network that provides edge computing and/or storage resources which are proximately located to radio access network (RAN) capable endpoint devices (e.g., mobile computing devices, IoT devices, smart devices, etc.), which are shown in FIG. 14 as the client compute nodes 1602. In other words, the edge cloud 1310 may be envisioned as an “edge” which connects the endpoint devices and traditional mobile network access points that serves as an ingress point into service provider core networks, including carrier networks (e.g., Global System for Mobile Communications (GSM) networks, Long-Term Evolution (LTE) networks, 5G networks, etc.), while also providing storage and/or compute capabilities. Other types and forms of network access (e.g., Wi-Fi, long-range wireless networks) may also be utilized in place of or in combination with such 3GPP carrier networks.

In some examples, the edge cloud 1310 may form a portion of or otherwise provide an ingress point into or across a fog networking configuration 1626 (e.g., a network of fog devices 1624, not shown in detail), which may be embodied as a system-level horizontal and distributed architecture that distributes resources and services to perform a specific function. For instance, a coordinated and distributed network of fog devices 1624 may perform computing, storage, control, or networking aspects in the context of an IoT system arrangement. Other networked, aggregated, and distributed functions may exist in the edge cloud 1310 between the cloud data center layer 1440 and the client endpoints (e.g., client compute nodes 1602). Some of these are discussed in the following sections in the context of network functions or service virtualization, including the use of virtual edges and virtual services which are orchestrated for multiple stakeholders.

The edge gateway nodes 1612 and the edge aggregation nodes 1622 cooperate to provide various edge services and security to the client compute nodes 1602. Furthermore, because a client compute node 1602 may be stationary or mobile, an edge gateway node 1612 may cooperate with other edge gateway devices to propagate presently provided edge services and security as the corresponding client compute node 1602 moves about a region. To do so, the edge gateway nodes 1612 and/or edge aggregation nodes 1622 may support multiple tenancy and multiple stakeholder configurations, in which services from (or hosted for) multiple service providers and multiple consumers may be supported and coordinated across a single or multiple compute devices.

In further examples, any of the compute nodes or devices discussed with reference to the present computing systems and environment may be fulfilled based on the components depicted in FIGS. 17A and 17B. A compute node may be embodied as a type of device, appliance, computer, or other “thing” capable of communicating with other edge, networking, or endpoint components.

In the simplified example depicted in FIG. 17A, an edge compute node 1700 includes a compute engine (also referred to herein as “compute circuitry”) 1702, an input/output (I/O) subsystem 1708, data storage device 1710, a communication circuitry 1712 subsystem, and, optionally, one or more peripheral devices 1714. In other examples, a compute device may include other or additional components, such as those used in personal or server computing systems (e.g., a display, peripheral devices, etc.). Additionally, in some examples, one or more of the illustrative components may be incorporated in, or otherwise form a portion of, another component.

The compute node 1700 may be embodied as any type of engine, device, or collection of devices capable of performing various compute functions. In some examples, the compute node 1700 may be embodied as a single device such as an integrated circuit, an embedded system, a field-programmable gate array (FPGA), a system-on-a-chip (SOC), or other integrated system or device. In the illustrative example, the compute node 1700 includes or is embodied as a processor 1704 and a memory 1706. The processor 1704 may be embodied as any type of processor capable of performing the functions described herein (e.g., executing an application). For example, the processor 1704 may be embodied as a multi-core processor(s), a microcontroller, or other processor or processing/controlling circuit. In some examples, the processor 1704 may be embodied as, include, or be coupled to an FPGA, an application specific integrated circuit (ASIC), reconfigurable hardware or hardware circuitry, or other specialized hardware to facilitate performance of the functions described herein.

The main memory 1706 may be embodied as any type of volatile (e.g., dynamic random access memory (DRAM), etc.) or non-volatile memory or data storage capable of performing the functions described herein. Volatile memory may be a storage medium that uses power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In one example, the memory device is a block addressable memory device, such as those based on NAND or NOR technologies. A memory device may also include a three-dimensional crosspoint memory device (e.g., Intel 3D Xpoint™ memory, other storage class memory), or other byte addressable write-in-place nonvolatile memory devices. The memory device may refer to the die itself and/or to a packaged memory product. In some examples, 3D crosspoint memory (e.g., Intel 3D Xpoint™ memory) may comprise a transistor-less stackable cross point architecture in which memory cells sit at the intersection of word lines and bit lines and are individually addressable and in which bit storage is based on a change in bulk resistance. In some examples, all or a portion of the main memory 1706 may be integrated into the processor 1704. The main memory 1706 may store various software and data used during operation such as one or more applications, data operated on by the application(s), libraries, and drivers.

The compute circuitry 1702 is communicatively coupled to other components of the compute node 1700 via the I/O subsystem 1708, which may be embodied as circuitry and/or components to facilitate input/output operations with the compute circuitry 1702 (e.g., with the processor 1704 and/or the main memory 1706) and other components of the compute circuitry 1702. For example, the I/O subsystem 1708 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1708 may form a portion of a system-on-a-chip (SoC) and be incorporated, along with one or more of the processor 1704, the main memory 1706, and other components of the compute circuitry 1702, into the compute circuitry 1702.

The one or more illustrative data storage device 1710 may be embodied as any type of devices configured for short-term or long-term storage of data such as, for example, memory devices and circuits, memory cards, hard disk drives, solid-state drives, or other data storage devices. A data storage device 1710 may include a system partition that stores data and firmware code for the data storage device 1710. A data storage device 1710 may also include one or more operating system partitions that store data files and executables for operating systems depending on, for example, the type of compute node 1700.

The communication circuitry 1712 may be embodied as any communication circuit, device, or collection thereof, capable of enabling communications over a network between the compute circuitry 1702 and another compute device (e.g., an edge gateway node 1612 of an edge computing system). The communication circuitry 1712 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, etc.) to effect such communication.

The illustrative communication circuitry 1712 includes a network interface controller (NIC) 1720, which may also be referred to as a host fabric interface (HFI). The NIC 1720 may be embodied as one or more add-in-boards, daughter cards, network interface cards, controller chips, chipsets, or other devices that may be used by the compute node 1700 to connect with another compute device (e.g., an edge gateway node 1612). In some examples, the NIC 1720 may be embodied as part of a system-on-a-chip (SoC) that includes one or more processors, or included on a multichip package that also contains one or more processors. In some examples, the NIC 1720 may include a local processor (not shown) and/or a local memory (not shown) that are both local to the NIC 1720. In such examples, the local processor of the NIC 1720 may be capable of performing one or more of the functions of the compute circuitry 1702 described herein. Additionally or alternatively, in such examples, the local memory of the NIC 1720 may be integrated into one or more components of the client compute node at the board level, socket level, chip level, and/or other levels.

Additionally, in some examples, a compute node 1700 may include one or more peripheral devices 1714. Such peripheral devices 1714 may include any type of peripheral device found in a compute device or server such as audio input devices, a display, other input/output devices, interface devices, and/or other peripheral devices, depending on the particular type of the compute node 1700. In further examples, the compute node 1700 may be embodied by a respective edge compute node in an edge computing system (e.g., client compute node 1602, edge gateway node 1612, edge aggregation node 1622) or like forms of appliances, computers, subsystems, circuitry, or other components.

In a more detailed example, FIG. 17B illustrates a block diagram of an example of components that may be present in an edge computing node 1750 for implementing the techniques (e.g., operations, processes, methods, and methodologies) described herein. The edge computing node 1750 may include any combinations of the components referenced above, and it may include any device usable with an edge communication network or a combination of such networks. The components may be implemented as ICs, portions thereof, discrete electronic devices, or other modules, logic, hardware, software, firmware, or a combination thereof adapted in the edge computing node 1750, or as components otherwise incorporated within a chassis of a larger system. Further, to support the security examples provided herein, a hardware RoT (e.g., provided according to a DICE architecture) may be implemented in a IP block of the edge computing node 1750 such that any IP Block may boot into a mode where a RoT identity may be generated that may attest its identity and its current booted firmware to another IP Block or to an external entity.

The edge computing node 1750 may include processing circuitry in the form of a processor 1752, which may be a microprocessor, a multi-core processor, a multithreaded processor, an ultra-low voltage processor, an embedded processor, or other known processing elements. The processor 1752 may be a part of a system on a chip (SoC) in which the processor 1752 and other components are formed into a single integrated circuit, or a single package, such as the Edison™ or Galileo™ SoC boards from Intel Corporation, Santa Clara, California. As an example, the processor 1752 may include an Intel® Architecture Core™ based processor, such as a Quark™, an Atom™, a Xeon™, an i3, an i5, an i7, an i9, or an MCU-class processor, or another such processor available from Intel®. However, any number other processors may be used, such as available from Advanced Micro Devices, Inc. (AMD) of Sunnyvale, California, a MIPS-based design from MIPS Technologies, Inc. of Sunnyvale, California, an ARM-based design licensed from ARM Holdings, Ltd. Or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc.

The processor 1752 may communicate with a system memory 1754 over an interconnect 1756 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1758 may also couple to the processor 1752 via the interconnect 1756. In an example, the storage 1758 may be implemented via a solid-state disk drive (SSDD). Other devices that may be used for the storage 1758 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magneto-resistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 1758 may be on-die memory or registers associated with the processor 1752. However, in some examples, the storage 1758 may be implemented using a micro hard disk drive (HDD). Further, any number of new technologies may be used for the storage 1758 in addition to, or instead of, the technologies described, such resistance change memories, phase change memories, holographic memories, or chemical memories, among others.

The components may communicate over the interconnect 1756. The interconnect 1756 may include any number of technologies, including industry standard architecture (ISA), extended ISA (EISA), peripheral component interconnect (PCI), peripheral component interconnect extended (PCI-X), PCI express (PCIe), NVLink, or any number of other technologies. The interconnect 1756 may be a proprietary bus, for example, used in an SoC based system. Other bus systems may be included, such as an I2C interface, an SPI interface, point to point interfaces, and a power bus, among others.

The interconnect 1756 may couple the processor 1752 to a transceiver 1766, for communications with the connected edge devices 1762. The transceiver 1766 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1762. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1766 (or multiple transceivers) may communicate using multiple standards or radios for communications at a different range. For example, the edge computing node 1750 may communicate with close devices, e.g., within about 10 meters, using a local transceiver based on BLE, or another low power radio, to save power. More distant connected edge devices 1762, e.g., within about 50 meters, may be reached over ZigBee or other intermediate power radios. Both communications techniques may take place over a single radio at different power levels or may take place over separate transceivers, for example, a local transceiver using BLE and a separate mesh transceiver using ZigBee.

A wireless network transceiver 1766 (e.g., a radio transceiver) may be included to communicate with devices or services in the edge cloud 1790 via local or wide area network protocols. The wireless network transceiver 1766 may be an LPWA transceiver that follows the IEEE 802.15.4, or IEEE 802.15.4g standards, among others. The edge computing node 1750 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1766, as described herein. For example, the transceiver 1766 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1766 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1768 may be included to provide a wired communication to nodes of the edge cloud 1790 or to other devices, such as the connected edge devices 1762 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1768 may be included to enable connecting to a second network, for example, a first NIC 1768 providing communications to the cloud over Ethernet, and a second NIC 1768 providing communications to other devices over another type of network.

Given the variety of types of applicable communications from the device to another component or network, applicable communications circuitry used by the device may include or be embodied by any one or more of components such as circuitry 1764, transceiver 1766, NIC 1768, or interface 1770. Accordingly, in various examples, applicable means for communicating (e.g., receiving, transmitting, etc.) may be embodied by such communications circuitry.

The edge computing node 1750 may include or be coupled to acceleration circuitry 1764, which may be embodied by one or more AI accelerators, a neural compute stick, neuromorphic hardware, an FPGA, an arrangement of GPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. Accordingly, in various examples, applicable means for acceleration may be embodied by such acceleration circuitry.

The interconnect 1756 may couple the processor 1752 to a sensor hub or external interface 1770 that is used to connect additional devices or subsystems. The devices may include sensors 1772, such as accelerometers, level sensors, flow sensors, optical light sensors, camera sensors, temperature sensors, a global positioning system (GPS) sensors, pressure sensors, barometric pressure sensors, and the like. The hub or interface 1770 further may be used to connect the edge computing node 1750 to actuators 1774, such as power switches, valve actuators, an audible sound generator, a visual warning device, and the like.

In some optional examples, various input/output (I/O) devices may be present within or connected to, the edge computing node 1750. For example, a display or other output device 1784 may be included to show information, such as sensor readings or actuator position. An input device 1786, such as a touch screen or keypad may be included to accept input. An output device 1784 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the edge computing node 1750.

A battery 1776 may power the edge computing node 1750, although, in examples in which the edge computing node 1750 is mounted in a fixed location, it may have a power supply coupled to an electrical grid. The battery 1776 may be a lithium ion battery, or a metal-air battery, such as a zinc-air battery, an aluminum-air battery, a lithium-air battery, and the like.

A battery monitor/charger 1778 may be included in the edge computing node 1750 to track the state of charge (SoCh) of the battery 1776. The battery monitor/charger 1778 may be used to monitor other parameters of the battery 1776 to provide failure predictions, such as the state of health (SoH) and the state of function (SoF) of the battery 1776. The battery monitor/charger 1778 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 1778 may communicate the information on the battery 1776 to the processor 1752 over the interconnect 1756. The battery monitor/charger 1778 may also include an analog-to-digital (ADC) converter that enables the processor 1752 to directly monitor the voltage of the battery 1776 or the current flow from the battery 1776. The battery parameters may be used to determine actions that the edge computing node 1750 may perform, such as transmission frequency, mesh network operation, sensing frequency, and the like.

A power block 1780, or other power supply coupled to a grid, may be coupled with the battery monitor/charger 1778 to charge the battery 1776. In some examples, the power block 1780 may be replaced with a wireless power receiver to obtain the power wirelessly, for example, through a loop antenna in the edge computing node 1750. A wireless battery charging circuit, such as an LTC4020 chip from Linear Technologies of Milpitas, California, among others, may be included in the battery monitor/charger 1778. The specific charging circuits may be selected based on the size of the battery 1776, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1758 may include instructions 1782 in the form of software, firmware, or hardware commands to implement the techniques described herein. Although such instructions 1782 are shown as code blocks included in the memory 1754 and the storage 1758, it may be understood that any of the code blocks may be replaced with hardwired circuits, for example, built into an application specific integrated circuit (ASIC).

In an example, the instructions 1782 provided via the memory 1754, the storage 1758, or the processor 1752 may be embodied as a non-transitory, machine-readable medium 1760 including code to direct the processor 1752 to perform electronic operations in the edge computing node 1750. The processor 1752 may access the non-transitory, machine-readable medium 1760 over the interconnect 1756. For instance, the non-transitory, machine-readable medium 1760 may be embodied by devices described for the storage 1758 or may include specific storage units such as optical disks, flash drives, or any number of other hardware devices. The non-transitory, machine-readable medium 1760 may include instructions to direct the processor 1752 to perform a specific sequence or flow of actions, for example, as described with respect to the flowchart(s) and block diagram(s) of operations and functionality depicted above. As used in, the terms “machine-readable medium” and “computer-readable medium” are interchangeable.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

The block diagrams of FIGS. 17A and 17B are intended to depict a high-level view of components of a device, subsystem, or arrangement of an edge computing node. However, it will be understood that some of the components shown may be omitted, additional components may be present, and a different arrangement of the components shown may occur in other implementations.

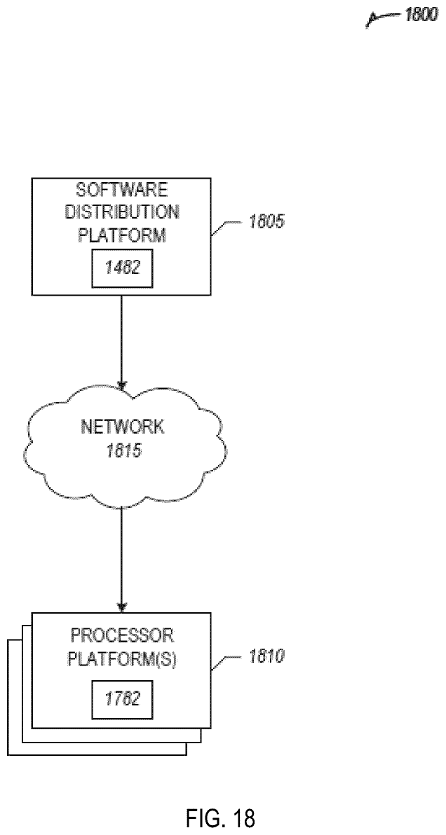

FIG. 18 illustrates an example software distribution platform 1805 to distribute software, such as the example computer readable instructions 1782 of FIG. 17B, to one or more devices, such as example processor platform(s) 1810 and/or other example connected edge devices or systems discussed herein. The example software distribution platform 1805 may be implemented by any computer server, data facility, cloud service, etc., capable of storing and transmitting software to other computing devices. Example connected edge devices may be customers, clients, managing devices (e.g., servers), third parties (e.g., customers of an entity owning and/or operating the software distribution platform 1805). Example connected edge devices may operate in commercial and/or home automation environments. In some examples, a third party is a developer, a seller, and/or a licensor of software such as the example computer readable instructions 1782 of FIG. 17B. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 18, the software distribution platform 1805 includes one or more servers and one or more storage devices that store the computer readable instructions 1782. The one or more servers of the example software distribution platform 1805 are in communication with a network 1815, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 1782 from the software distribution platform 1805. For example, the software, which may correspond to example computer readable instructions, may be downloaded to the example processor platform(s), which is/are to execute the computer readable instructions 1782. In some examples, one or more servers of the software distribution platform 1805 are communicatively connected to one or more security domains and/or security devices through which requests and transmissions of the example computer readable instructions 1782 must pass. In some examples, one or more servers of the software distribution platform 1805 periodically offer, transmit, and/or force updates to the software (e.g., the example computer readable instructions 1782 of FIG. 17B) to ensure improvements, patches, updates, etc. are distributed and applied to the software at the end user devices.

In the illustrated example of FIG. 18, the computer readable instructions 1782 are stored on storage devices of the software distribution platform 1805 in a particular format. A format of computer readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 1782 stored in the software distribution platform 1805 are in a first format when transmitted to the example processor platform(s) 1810. In some examples, the first format is an executable binary in which particular types of the processor platform(s) 1810 can execute. However, in some examples, the first format is uncompiled code that uses one or more preparation tasks to transform the first format to a second format to enable execution on the example processor platform(s) 1810. For instance, the receiving processor platform(s) 1800 may need to compile the computer readable instructions 1782 in the first format to generate executable code in a second format that is capable of being executed on the processor platform(s) 1810. In still other examples, the first format is interpreted code that, upon reaching the processor platform(s) 1810, is interpreted by an interpreter to facilitate execution of instructions.

### EXAMPLES

Example 1 is a 5th generation (5G) network device, comprising: processing circuitry; and a memory device including instructions embodied thereon, wherein the instructions, which when executed by the processing circuitry, configure the processing circuitry to perform operations in a 5G mobile data network to: for a plurality of antennas associated with a first Radio Unit (RU) coupled to a distributed unit (DU), correct times of arrival of a reference signal transmitted from a dynamic UE received by the plurality of antennas based on timing offsets corresponding to the plurality of antennas, the reference signal having a periodicity synchronized to a second reference signal used to determine the timing offset; and determine time difference of arrivals based on the times of arrival and the timing offsets at the plurality of antennas to determine a location of the dynamic UE.

In Example 2, the subject matter of Example 1 includes, G network to: determine second times of arrival of a second reference signal transmitted by a stationary UE and collected by the plurality of antennas; determine timing offsets for the plurality of antennas based on the second reference signal, a known location of the stationary UE and known locations of the plurality of antennas; correct for the second times of arrival of the second reference signal at the plurality of antennas based on the timing offsets corresponding to the plurality of antennas; and determine a time difference of arrival based on the second times of arrival and the timing offsets at the plurality of antennas to confirm the location of the stationary UE.

In Example 3, the subject matter of Example 2 includes, wherein the reference signal is collected by a first timing reference unit in the stationary UE, the timing offsets are determined at a second timing reference unit in the DU, and the times of arrival and the timing offsets for the plurality of antennas are sent from the DU to a location engine for correction of the times of arrival and location determination of the dynamic UE.

In Example 4, the subject matter of Examples 2-3 includes, G network to: for a second plurality of antennas associated with a second RU coupled to the DU, correct times of arrival of a third reference signal transmitted from the dynamic UE received by the plurality of antennas based on second timing offsets corresponding to the plurality of antennas, the third reference signal having a periodicity synchronized to the second reference signal used to determine the second timing offsets; and determine a second time difference of arrival based on the times of arrival of the third reference signal and the second timing offsets at the second plurality of antennas to determine the location of the dynamic UE.

In Example 5, the subject matter of Examples 2-4 includes, wherein the reference signals and the second reference signals are sounding reference signals.

In Example 6, the subject matter of Examples 2-5 includes, wherein the second reference signals are transmitted within a few milliseconds of the reference signals.

In Example 7, the subject matter of Examples 1-6 includes, G network to: use an artificial intelligence (AI) model to process time synchronization data associated with the timing offsets, based on variables that include temperature, time of day, and network activities, and implement adaptive corrections and adjustments based on the AI model to address service disruptions caused by time synchronization issues.

In Example 8, the subject matter of Example 7 includes, G network to: publish the timing offsets for application adjustments to make the timing offsets available for network operations and positioning functions, and collect feedback from the 5G network to refine the AI model and improve future synchronization accuracy by analyzing effectiveness of the timing offsets and adjusting the AI model.

In Example 9, the subject matter of Examples 7-8 includes, wherein the instructions, when executed by the processing circuitry, configure the processing circuitry to train a single AI model using combined data from both a parent Integrated Access Backhaul (IAB)-Donor and a child IAB Node.

In Example 10, the subject matter of Examples 7-9 includes, wherein the instructions, when executed by the processing circuitry, configure the processing circuitry to train separate AI models at a parent Integrated Access Backhaul (IAB)-Donor and a child IAB Node, each AI model tailored to specific conditions and data of a respective node, the AI models sharing insights or parameters.

In Example 11, the subject matter of Examples 7-10 includes, wherein: the instructions, when executed by the processing circuitry, configure the processing circuitry to train the AI model through collaboration between different network elements, and precision time protocol (PTP) signals are used across ground-based RUs and DUs for time synchronization in a terrestrial network (TN) to account for terrestrial-specific factors including temperature and interference from physical obstructions when applying timing offsets.

In Example 12, the subject matter of Examples 7-11 includes, wherein: the instructions, when executed by the processing circuitry, configure the processing circuitry to train the AI model through collaboration between different network elements, and precision time protocol (PTP) signals are used for time synchronization between space-based and ground-based network elements in non-terrestrial network (NTN) to account for higher latency and signal propagation delays in satellite communications and adapt synchronization techniques to handle dynamic nature of the NTN, including moving satellites and varying atmospheric conditions.

In Example 13, the subject matter of Examples 1-12 includes, G network to prioritize less congested signal paths, and adjust weights using environmental factors that affect signal reliability.

In Example 14, the subject matter of Examples 1-13 includes, wherein the instructions, when executed by the processing circuitry, configure the processing circuitry to modify internal clocks of the DU and RUs coupled to the DU to align with the timing offset.

Example 15 is a non-transitory memory including instructions embodied thereon, wherein the instructions, which when executed by processing circuitry, configure the processing circuitry to perform operations for time synchronization in a 5th generation (5G) network, to: collect periodic time synchronization data of a plurality of pairs of a Distributed Unit (DU) and Radio Units (RUs) at Time sync Reference Unit (TRU) instances, the TRU instances corresponding to different pairs of the DU and the RUs, the time synchronization data derived from precision time protocol (PTP) signals that used as part of an IEEE 1588 standard to synchronize clocks across one or more networks, calculate time synchronization deltas among the time synchronization data, average the time synchronization deltas to determine a synchronization offset, and apply the synchronization offset to adjust timing of the RUs and DU.

In Example 16, the subject matter of Example 15 includes, G network to: use an artificial intelligence (AI) model to process the time synchronization data, accounting for variables that include temperature, time of day, and network activities, implement adaptive corrections and adjustments based on the AI model to address service disruptions caused by time synchronization issues, publish the synchronization offset for application adjustments to make the synchronization offset available for network operations and positioning functions, and collect feedback from the 5G network to refine the AI model and improve future synchronization accuracy by analyzing effectiveness of the synchronization offset and adjusting the AI model.

In Example 17, the subject matter of Example 16 includes, wherein the instructions, when executed by the processing circuitry, configure the processing circuitry to train a single AI model using combined data from both a parent Integrated Access Backhaul (IAB)-Donor and a child IAB Node.

In Example 18, the subject matter of Examples 16-17 includes, wherein the instructions, when executed by the processing circuitry, configure the processing circuitry to train separate AI models at a parent Integrated Access Backhaul (IAB)-Donor and a child IAB Node, each AI model tailored to specific conditions and data of a respective node, the AI models sharing insights or parameters.

Example 19 is a method for time synchronization in a 5th generation (5G) network, the method comprising: collecting periodic time synchronization data of a plurality of pairs of a Distributed Unit (DU) and Radio Units (RUs) at Time sync Reference Unit (TRU) instances, the TRU instances corresponding to different pairs of the DU and the RUs, the time synchronization data derived from precision time protocol (PTP) signals that used as part of an IEEE 1588 standard to synchronize clocks across one or more networks, calculating time synchronization deltas among the time synchronization data, averaging the time synchronization deltas to determine a synchronization offset, and applying the synchronization offset to adjust timing of the RUs and DU.

In Example 20, the subject matter of Example 19 includes, using an artificial intelligence (AI) model to process the time synchronization data, accounting for variables that include temperature, time of day, and network activities, implementing adaptive corrections and adjustments based on the AI model to address service disruptions caused by time synchronization issues, publishing the synchronization offset for application adjustments to make the synchronization offset available for network operations and positioning functions, and collecting feedback from the 5G network to refine the AI model and improve future synchronization accuracy by analyzing effectiveness of the synchronization offset and adjusting the AI model.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although specific example embodiments are described, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, the subject matter herein lies in less than all features of a single disclosed embodiment. Thus, the following claims are hereby incorporated into the Detailed Description, with each claim standing on its own as a separate embodiment.

What is claimed is:

1. A 5^{th} generation (5G) network device, comprising:
processing circuitry; and
a memory device including instructions embodied thereon, wherein the instructions, which when executed by the processing circuitry, configure the processing circuitry to perform operations in a 5G mobile data network to:
for a plurality of antennas associated with a first Radio Unit (RU) coupled to a distributed unit (DU), correct times of arrival of a reference signal transmitted from a dynamic UE received by the plurality of antennas based on timing offsets corresponding to the plurality of antennas, the reference signal having a periodicity synchronized to a second reference signal used to determine the timing offset; and
determine time difference of arrivals based on the times of arrival and the timing offsets at the plurality of antennas to determine a location of the dynamic UE.

2. The device of claim 1, wherein the instructions, when executed by the processing circuitry, configure the processing circuitry to perform further operations for time synchronization in the 5G network to:
determine second times of arrival of a second reference signal transmitted by a stationary UE and collected by the plurality of antennas;
determine timing offsets for the plurality of antennas based on the second reference signal, a known location of the stationary UE and known locations of the plurality of antennas;
correct for the second times of arrival of the second reference signal at the plurality of antennas based on the timing offsets corresponding to the plurality of antennas; and
determine a time difference of arrival based on the second times of arrival and the timing offsets at the plurality of antennas to confirm the location of the stationary UE.

3. The device of claim 2, wherein the reference signal is collected by a first timing reference unit in the stationary UE, the timing offsets are determined at a second timing reference unit in the DU, and the times of arrival and the timing offsets for the plurality of antennas are sent from the DU to a location engine for correction of the times of arrival and location determination of the dynamic UE.

4. The device of claim 2, wherein the instructions, when executed by the processing circuitry, configure the processing circuitry to perform further operations for time synchronization in the 5G network to:
for a second plurality of antennas associated with a second RU coupled to the DU, correct times of arrival of a third reference signal transmitted from the dynamic UE received by the plurality of antennas based on second timing offsets corresponding to the plurality of antennas, the third reference signal having a periodicity synchronized to the second reference signal used to determine the second timing offsets; and
determine a second time difference of arrival based on the times of arrival of the third reference signal and the second timing offsets at the second plurality of antennas to determine the location of the dynamic UE.

5. The device of claim 2, wherein the reference signals and the second reference signals are sounding reference signals.

6. The device of claim 2, wherein the second reference signals are transmitted within a few milliseconds of the reference signals.

7. The device of claim 1, wherein the instructions, when executed by the processing circuitry, configure the processing circuitry to perform further operations for time synchronization in the 5G network to:
use an artificial intelligence (AI) model to process time synchronization data associated with the timing offsets, based on variables that include temperature, time of day, and network activities, and
implement adaptive corrections and adjustments based on the AI model to address service disruptions caused by time synchronization issues.

8. The device of claim 7, wherein the instructions, when executed by the processing circuitry, configure the processing circuitry to perform further operations for time synchronization in the 5G network to:
publish the timing offsets for application adjustments to make the timing offsets available for network operations and positioning functions, and
collect feedback from the 5G network to refine the AI model and improve future synchronization accuracy by analyzing effectiveness of the timing offsets and adjusting the AI model.

9. The device of claim 7, wherein the instructions, when executed by the processing circuitry, configure the processing circuitry to train a single AI model using combined data from both a parent Integrated Access Backhaul (IAB)-Donor and a child IAB Node.

10. The device of claim 7, wherein the instructions, when executed by the processing circuitry, configure the processing circuitry to train separate AI models at a parent Integrated Access Backhaul (IAB)-Donor and a child IAB Node, each AI model tailored to specific conditions and data of a respective node, the AI models sharing insights or parameters.

11. The device of claim 7, wherein:
the instructions, when executed by the processing circuitry, configure the processing circuitry to train the AI model through collaboration between different network elements, and
precision time protocol (PTP) signals are used across ground-based RUs and DUs for time synchronization in a terrestrial network (TN) to account for terrestrial-specific factors including temperature and interference from physical obstructions when applying timing offsets.

12. The device of claim 7, wherein:
the instructions, when executed by the processing circuitry, configure the processing circuitry to train the AI model through collaboration between different network elements, and
precision time protocol (PTP) signals are used for time synchronization between space-based and ground-based network elements in non-terrestrial network (NTN) to account for higher latency and signal propagation delays in satellite communications and adapt synchronization techniques to handle dynamic nature of the NTN, including moving satellites and varying atmospheric conditions.

13. The device of claim 1, wherein the instructions, when executed by the processing circuitry, configure the processing circuitry to average timing offsets obtained from different RUs coupled to the DU using a weighted average of the timing offsets, the weighting including one or more of: assigning higher weights to timing offsets with better quality or lower jitter, giving more weight to timing offsets from RUs that are closer to the DU, assigning higher weights to RUs that have consistently provided accurate timing based on historical data, adjusting weights based on current load or traffic conditions of the 5G network to prioritize less congested signal paths, and adjust weights using environmental factors that affect signal reliability.

14. The device of claim 1, wherein the instructions, when executed by the processing circuitry, configure the processing circuitry to modify internal clocks of the DU and RUs coupled to the DU to align with the timing offset.

15. A non-transitory memory including instructions embodied thereon, wherein the instructions, which when executed by processing circuitry, configure the processing circuitry to perform operations for time synchronization in a 5^{th} generation (5G) network, to:
collect periodic time synchronization data of a plurality of pairs of a Distributed Unit (DU) and Radio Units (RUs) at Time sync Reference Unit (TRU) instances, the TRU instances corresponding to different pairs of the DU and the RUs, the time synchronization data derived from precision time protocol (PTP) signals that used as part of an IEEE 1588 standard to synchronize clocks across one or more networks,
calculate time synchronization deltas among the time synchronization data,
average the time synchronization deltas to determine a synchronization offset, and
apply the synchronization offset to adjust timing of the RUs and DU.

16. The non-transitory memory of claim 15, wherein the instructions, when executed by the processing circuitry, configure the processing circuitry to perform further operations for time synchronization in the 5G network to:
use an artificial intelligence (AI) model to process the time synchronization data, accounting for variables that include temperature, time of day, and network activities,
implement adaptive corrections and adjustments based on the AI model to address service disruptions caused by time synchronization issues,
publish the synchronization offset for application adjustments to make the synchronization offset available for network operations and positioning functions, and
collect feedback from the 5G network to refine the AI model and improve future synchronization accuracy by analyzing effectiveness of the synchronization offset and adjusting the AI model.

17. The non-transitory memory of claim 16, wherein the instructions, when executed by the processing circuitry, configure the processing circuitry to train a single AI model using combined data from both a parent Integrated Access Backhaul (IAB)-Donor and a child IAB Node.

18. The non-transitory memory of claim 16, wherein the instructions, when executed by the processing circuitry, configure the processing circuitry to train separate AI models at a parent Integrated Access Backhaul (IAB)-Donor and a child IAB Node, each AI model tailored to specific conditions and data of a respective node, the AI models sharing insights or parameters.

19. A method for time synchronization in a 5^{th} generation (5G) network, the method comprising:
collecting periodic time synchronization data of a plurality of pairs of a Distributed Unit (DU) and Radio Units (RUs) at Time sync Reference Unit (TRU) instances, the TRU instances corresponding to different pairs of the DU and the RUs, the time synchronization data derived from precision time protocol (PTP) signals that used as part of an IEEE 1588 standard to synchronize clocks across one or more networks,
calculating time synchronization deltas among the time synchronization data,
averaging the time synchronization deltas to determine a synchronization offset, and
applying the synchronization offset to adjust timing of the RUs and DU.

20. The method of claim 19, further comprising:
using an artificial intelligence (AI) model to process the time synchronization data, accounting for variables that include temperature, time of day, and network activities,
implementing adaptive corrections and adjustments based on the AI model to address service disruptions caused by time synchronization issues,
publishing the synchronization offset for application adjustments to make the synchronization offset available for network operations and positioning functions, and
collecting feedback from the 5G network to refine the AI model and improve future synchronization accuracy by analyzing effectiveness of the synchronization offset and adjusting the AI model.
